(19) United States
(12) Patent Application Publication
(10) Pub. No.: US 2025/0063596 A1
(43) Pub. Date: Feb. 20, 2025

(54) LOW LATENCY CHANNEL ACCESS

(71) Applicant: QUALCOMM Incorporated, San Diego, CA (US)

(72) Inventors: Abdel Karim AJAMI, San Diego, CA (US); George CHERIAN, San Diego, CA (US); Alfred ASTERJADHI, San Diego, CA (US); Sai Yiu Duncan HO, San Diego, CA (US); Abhishek Pramod PATIL, San Diego, CA (US); Youhan KIM, Saratoga, CA (US); Yanjun SUN, San Diego, CA (US); Gaurang NAIK, San Diego, CA (US); Guido Robert FREDERIKS, Watsonville, CA (US)

(21) Appl. No.: 18/450,342

(22) Filed: Aug. 15, 2023

(51) Int. Cl. H04W 74/08; H04L 5/00; H04W 72/0453

(52) U.S. Cl. CPC H04W 74/0816; H04L 5/0048; H04W 72/0453

(57) ABSTRACT

This disclosure provides methods, components, devices and systems for low latency channel access. Some aspects more specifically relate to preemption of existing transmission opportunities (TXOPs) such that devices with low latency traffic to transmit may access the communication medium to transmit low latency traffic. Short physical layer protocol data units (PPDUs) may be used within TXOPs with interframe spaces between the PPDUs such that a device with low latency traffic may transmit a preemption indication during the interframe space. A first wireless communication device may identify low latency traffic during a first PPDU of a TXOP assigned to a second wireless communication device. The first wireless communication device may transmit a preemption indication in an interframe space that indicates that a subsequent scheduled PPDU in the TXOP will be preempted in order for the first wireless communication device to transmit a PPDU to convey the low latency traffic.

### TECHNICAL FIELD

This disclosure relates to wireless communication and, more specifically, to low latency channel access.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a transmission opportunity (TXOP) may be assigned to a device, for example, an AP or a STA. In some examples, one physical layer protocol data unit (PPDU) may be transmitted per TXOP. In such examples, if another device, such as a STA for an AP TXOP or the AP for a STA TXOP identifies low latency traffic for transmission, the other device waits until the end of the TXOP to transmit the low latency traffic, which may result in delay of low latency data or traffic.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless communication device is described. The method may include transmitting, in an interframe space between an end time of a first physical layer protocol data unit (PPDU) from a second wireless communication device and a scheduled start time for a second PPDU from the second wireless communication device, a preemption indication associated with low latency data at the first wireless communication device, where the first PPDU and the second PPDU are scheduled within a TXOP (TXOP) associated with the second wireless communication device and transmitting, based on the preemption indication, a third PPDU, where the third PPDU preempts the second PPDU within the TXOP.

Another innovative aspect of the subject matter described in this disclosure can be implemented in a first wireless communication device for wireless communications is described. The first wireless communication device may include a processing system that includes processor circuitry and memory circuitry that stores code. The processing system may be configured to cause the first wireless communication device to transmit, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and transmit, based on the preemption indication, a third PPDU, where the third PPDU preempts the second PPDU within the TXOP.

Another innovative aspect of the subject matter described in this disclosure can be implemented in a first wireless communication device for wireless communications is described. The first wireless communication device may include means for transmitting, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and means for transmitting, based on the preemption indication, a third PPDU, where the third PPDU preempts the second PPDU within the TXOP.

Another innovative aspect of the subject matter described in this disclosure can be implemented in a non-transitory computer-readable medium storing code for wireless communications is described. The code may include instructions executable by a processor to transmit, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and transmit, based on the preemption indication, a third PPDU, where the third PPDU preempts the second PPDU within the TXOP.

Some examples of the method, first wireless communication devices, and non-transitory computer-readable medium described herein may further include operations, features, means, or instructions for receiving, in the first PPDU, a preemption allowed indication for the TXOP, where transmission of the preemption indication may be based on the preemption allowed indication.

Some examples of the method, first wireless communication devices, and non-transitory computer-readable medium described herein may further include operations, features, means, or instructions for transmitting, to the second wireless communication device in the interframe space, a response frame for the first PPDU, where transmission of the preemption indication may be subsequent to transmission of the response frame.

Some examples of the method, first wireless communication devices, and non-transitory computer-readable medium described herein may further include operations, features, means, or instructions for transmitting a response for the first PPDU in a same frame as the preemption indication.

Some examples of the method, first wireless communication devices, and non-transitory computer-readable medium described herein may further include operations, features, means, or instructions for receiving, in the first PPDU, an indication of a broadcast resource unit for transmission of the preemption indication, where the preemption indication may be transmitted via the broadcast resource unit.

Some examples of the method, first wireless communication devices, and non-transitory computer-readable medium described herein may further include operations, features, means, or instructions for receiving, from the second wireless communication device, a frame in response to the preemption indication, where transmission of the third PPDU may be responsive to the frame.

Some examples of the method, first wireless communication devices, and non-transitory computer-readable medium described herein may further include operations, features, means, or instructions for performing, based on transmission of the preemption indication, a listen before talk procedure within a time period after the preemption indication, where transmission of the third PPDU may be based on the listen before talk procedure, where a duration of the time period may be indicated by the second wireless communication device to the first wireless communication device, and where transmission of the third PPDU may be within a grant duration indicated by the second wireless communication device to the first wireless communication device.

In some examples of the method, first wireless communication devices, and non-transitory computer-readable medium described herein, the listen before talk procedure uses a sub-slot granularity to determine a starting time for the third PPDU and a sub-slot may have a duration of less than 9 microseconds.

In some examples of the method, first wireless communication devices, and non-transitory computer-readable medium described herein, the third PPDU may be transmitted a period of time corresponding to a second interframe space after transmission of the preemption indication.

Some examples of the method, first wireless communication devices, and non-transitory computer-readable medium described herein may further include operations, features, means, or instructions for receiving, from the second wireless communication device, an indication of a duration of the second interframe space.

Some examples of the method, first wireless communication devices, and non-transitory computer-readable medium described herein may further include operations, features, means, or instructions for receiving, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU may be scheduled for reception within the TXOP and refraining from monitoring for the fourth PPDU based on the second preemption indication.

Some examples of the method, first wireless communication devices, and non-transitory computer-readable medium described herein may further include operations, features, means, or instructions for receiving, from the second wireless communication device, a response frame for the third PPDU that includes a preemption allowed indication for the TXOP, where reception of the second preemption indication may be responsive to the preemption allowed indication.

One innovative aspect of the subject matter described in this disclosure can be implemented in a method for wireless communications by a second wireless communication device is described. The method may include receiving, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and receiving, from the first wireless communication device and based on the preemption indication, a third PPDU, where the third PPDU preempts the second PPDU within the TXOP.

Another innovative aspect of the subject matter described in this disclosure can be implemented in a second wireless communication device for wireless communications is described. The second wireless communication device may include a processing system that includes processor circuitry and memory circuitry that stores code. The processing system may be configured to cause the second wireless communication device to receive, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and receive, from the first wireless communication device and based on the preemption indication, a third PPDU, where the third PPDU preempts the second PPDU within the TXOP.

Another innovative aspect of the subject matter described in this disclosure can be implemented in a second wireless communication device for wireless communications is described. The second wireless communication device may include means for receiving, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and means for receiving, from the first wireless communication device and based on the preemption indication, a third PPDU, where the third PPDU preempts the second PPDU within the TXOP.

Another innovative aspect of the subject matter described in this disclosure can be implemented in a non-transitory computer-readable medium storing code for wireless communications is described. The code may include instructions executable by a processor to receive, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device and receive, from the first wireless communication device and based on the preemption indication, a third PPDU, where the third PPDU preempts the second PPDU within the TXOP.

Some examples of the method, second wireless communication devices, and non-transitory computer-readable medium described herein may further include operations, features, means, or instructions for transmitting, in the first PPDU, a preemption allowed indication for the TXOP, where reception of the preemption indication may be based on the preemption allowed indication.

Some examples of the method, second wireless communication devices, and non-transitory computer-readable medium described herein may further include operations, features, means, or instructions for receiving, from the first wireless communication device in the interframe space, a response frame for the first PPDU, where reception of the preemption indication may be subsequent to reception of the response frame.

Some examples of the method, second wireless communication devices, and non-transitory computer-readable medium described herein may further include operations, features, means, or instructions for receiving, from the first wireless communication device, a response frame for the first PPDU in a same frame as the preemption indication.

Some examples of the method, second wireless communication devices, and non-transitory computer-readable medium described herein may further include operations, features, means, or instructions for transmitting, in the first PPDU, an indication of a broadcast resource unit for transmission of the preemption indication, where the preemption indication may be received via the broadcast resource unit.

Some examples of the method, second wireless communication devices, and non-transitory computer-readable medium described herein may further include operations, features, means, or instructions for transmitting a frame in response to the preemption indication, where reception of the third PPDU may be responsive to the frame.

In some examples of the method, second wireless communication devices, and non-transitory computer-readable medium described herein, the third PPDU may be received a period of time corresponding to a second interframe space after reception of the preemption indication.

Some examples of the method, second wireless communication devices, and non-transitory computer-readable medium described herein may further include operations, features, means, or instructions for transmitting, to the first wireless communication device, an indication of a duration of the second interframe space.

Some examples of the method, second wireless communication devices, and non-transitory computer-readable medium described herein may further include operations, features, means, or instructions for receiving, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU may be scheduled for reception within the TXOP and receiving, from the third wireless communication device and based on the second preemption indication, a fifth PPDU, where the fifth PPDU preempts the fourth PPDU within the TXOP.

Some examples of the method, second wireless communication devices, and non-transitory computer-readable medium described herein may further include operations, features, means, or instructions for transmitting a response frame for the third PPDU that includes a preemption allowed indication for the TXOP, where reception of the second preemption indication may be responsive to the preemption allowed indication.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a transmission opportunity (TXOP) timing diagram that supports low latency channel access.

FIG. 6 shows an example of a downlink TXOP timing diagram with mechanisms to trigger uplink transmissions that supports low latency channel access.

FIG. 7 shows an example of a downlink TXOP timing diagram with trigger-based preemption of transmissions with a TXOP that supports low latency channel access.

FIG. 8 shows an example of a downlink TXOP timing diagram with EDCA-based preemption of transmissions with a TXOP that supports low latency channel access.

FIG. 9 shows an example of a timing diagram for a low latency enhanced distributed channel access (EDCA) grant during a downlink TXOP with immediate backoff that supports low latency channel access.

FIG. 10 shows an example of a timing diagram for a low latency EDCA grant during a downlink TXOP with immediate backoff that supports low latency channel access.

FIG. 11 shows an example of a timing diagram for a low latency EDCA grant during an uplink TXOP that supports low latency channel access.

FIG. 12 shows an example of a timing diagram for a low latency EDCA grant during a downlink TXOP that supports low latency channel access.

FIG. 13 shows an example of a timing diagram for a low latency EDCA grant during a downlink TXOP that supports low latency channel access.

FIG. 14 shows an example of a timing diagram for a low latency EDCA grant during a downlink TXOP that supports low latency channel access.

FIG. 15 shows an example of a timing diagram that includes an AP multi-cast solicitation mechanism before a low latency EDCA grant that supports low latency channel access.

FIG. 16 shows an example of a process flow that supports low latency channel access.

FIG. 17 shows a block diagram of an example wireless communication device that supports low latency channel access.

FIG. 18 shows a flowchart illustrating an example process performable by or at a first wireless communication device that supports low latency channel access.

FIG. 19 shows a flowchart illustrating an example process performable by or at a second wireless communication device that supports low latency channel access.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to preempting existing transmission opportunities (TXOPs) such that devices with low latency traffic to transmit may access the communication medium during the TXOP to transmit the low latency traffic. Some aspects more specifically relate to using relatively short physical layer protocol data units (PPDUs) within TXOPs with interframe spaces between the PPDUs such that a device with low latency traffic to transmit may transmit a preemption indication during the interframe space. Short PPDUs may refer to PPDUs in scenarios where multiple PPDUs are scheduled in a single TXOP. In some examples, a first wireless communication device, such as an ultra-high reliability (UHR) wireless station (STA) or an access point (AP), may identify low latency traffic during a first PPDU of a TXOP assigned to a second wireless communication device. The first wireless communication device may transmit a preemption indication in an interframe space (such as a point coordination function interframe space (PIFS) or a short interframe space (SIFS)). The preemption indication may indicate that a subsequent scheduled PPDU in the TXOP will be preempted to allow the first wireless communication device to transmit a PPDU to convey the low latency traffic. In some examples, the first PPDU may indicate that preemption of the second PPDU is allowed (such as in a PHY header or a receiver address for the preemption indication).

Particular aspects of the subject matter described in this disclosure can be implemented to realize one or more of the following potential advantages. In some examples, by using short PPDUs within a TXOP, the described techniques can allow other devices to preempt other transmissions within the TXOP to transmit low latency traffic. Allowing preemption of a TXOP in order to transmit low latency traffic can reduce the time to transmit the low latency data, and thus may improve latency. The holder of the TXOP may be unaware that another device has low latency traffic to transmit, and thus a preemption indication may enable a device to indicate that the device have low latency traffic to transmit in order to preempt a PPDU from the TXOP holder. The TXOP holder may accordingly delay or postpone transmission of less urgent traffic that would have been transmitted in the preempted PPDU.

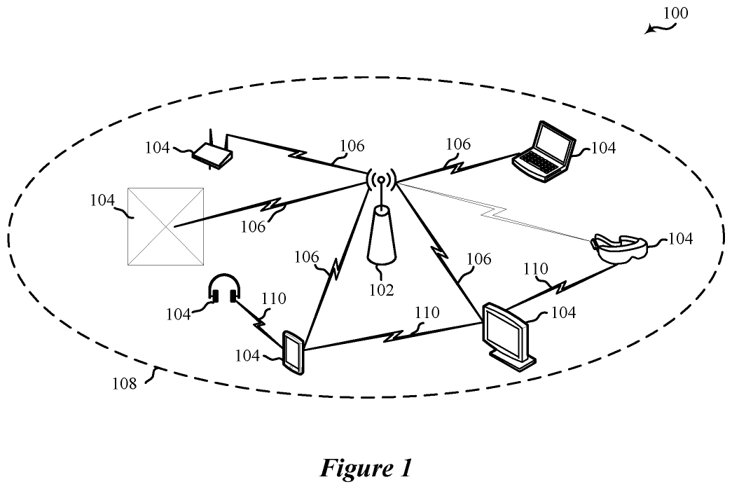

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHz, 480 MHz, or 640 MHz by bonding together multiple 20 MHz channels.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHZ, 80 MHZ, 160 MHZ, 240 MHZ, and 320 MHZ. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHZ bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

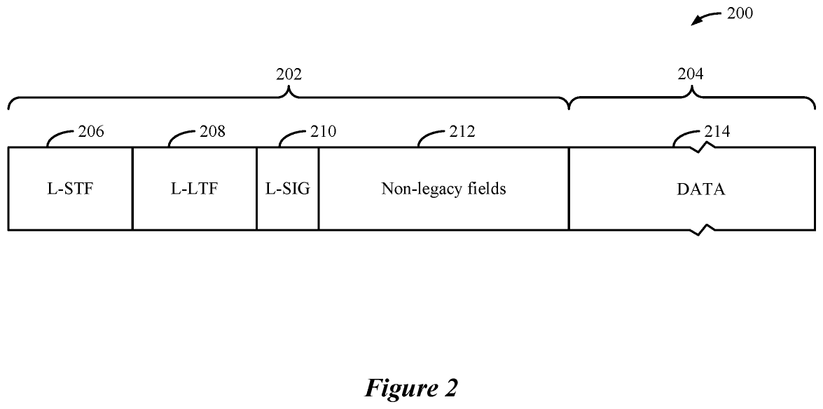

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

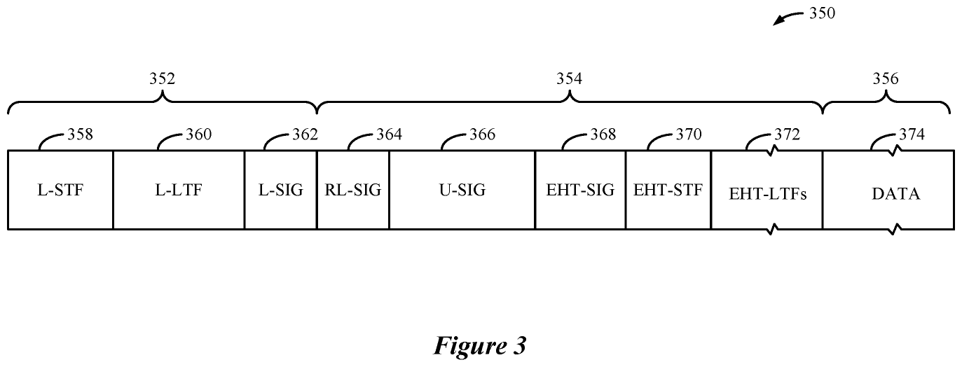

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

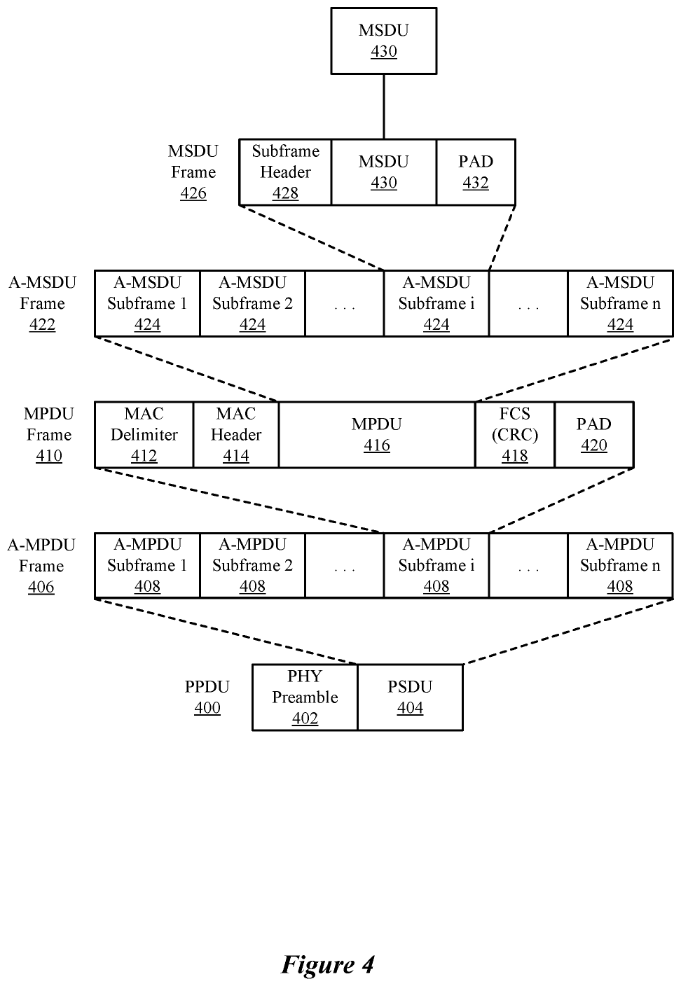

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 (shown as MSDU frame 426) contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or RUs associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz. 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHZ and 640 MHZ), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network WLAN 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

Some wireless devices, such as STAs 104 and APs 102 may implement UHR. UHR may include low latency channel access enhancements to improve latency for event driven traffic use cases. Two potential enhancement scenarios include preemption within a TXOP for downlink event-driven and/or aperiodic low latency traffic and preemption within a TXOP for uplink event-driven and/or aperiodic low latency traffic. For event-driven low latency data, a STA 104 with low latency event-driven traffic may not be the TXOP holder or responder, and therefore such a STA 104 waits for the current TXOP holder to finish its transmissions. For low latency event-driven uplink traffic, the AP 102 does not know which non-AP STA 104 has such low-latency traffic in its queue and what is the size of such low-latency traffic.

STAs 104 and APs 102 may use techniques described herein to preempt TXOPs in order to transmit low latency traffic. For example, TXOPs may be scheduled with interframe spaces between the PPDUs such that a device with low latency traffic to transmit may transmit a preemption indication during the interframe space. Low latency traffic may also be referred to as latency sensitive traffic. In some examples, a first wireless communication device, such as a UHR STA 104 or an AP 102 may identify low latency traffic during a first PPDU of a TXOP assigned to a second wireless communication device. The first wireless communication device may transmit a preemption indication in an interframe space (such as a PIFS or a SIFS) that indicates that a subsequent scheduled PPDU in the TXOP will be preempted for the first wireless communication device to transmit a PPDU to convey the low latency traffic.

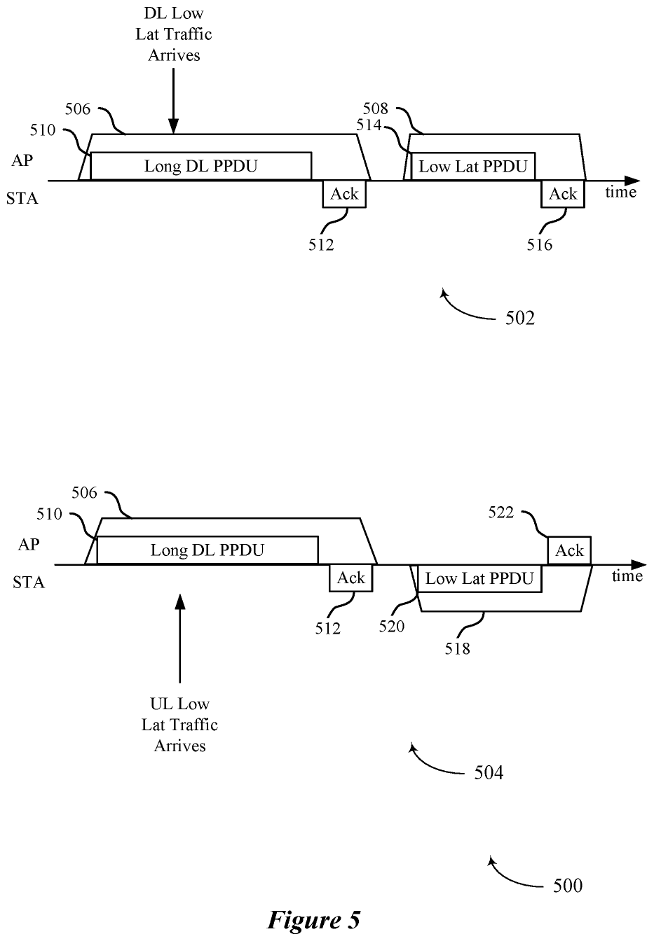

FIG. 5 shows an example of a TXOP timing diagram 500 that supports low latency channel access. The TXOP timing diagram 500 may implement or may be implemented by aspects of the wireless communication network 100.

A first example TXOP timing diagram 502 shows a downlink low latency event-driven traffic scenario. The second example TXOP timing diagram 504 shows an example uplink low latency event-driven traffic scenario.

In the first example TXOP timing diagram 502, an AP 102 may be the TXOP holder for a first TXOP 506. The AP 102 may transmit a long downlink PPDU 510 in the first TXOP 506, where a long PPDU refers to a scenario where only one PPDU is transmitted within a TXOP, as in the first TXOP 506. A STA 104 which receives the long downlink PPDU 510 may transmit an acknowledgment 512 for the long downlink PPDU 510 within the first TXOP 506. An “Ack” as shown in FIGS. 5-11 may refer to an ACK as described herein. During transmission of the long downlink PPDU 510, a new downlink low latency packet may arrive at the AP 102 for transmission (labeled in diagram 502 as “DL Low Lat Traffic Arrives”). The AP 102 waits until a second TXOP 508 to transmit the downlink low latency packet in a PPDU 514 (labeled in diagram 502 as “Low Lat PPDU”). The STA 104 may transmit an acknowledgment 516 for the PPDU 514 within the second TXOP 508. The second TXOP 508 may be a low latency TXOP and the PPDU 514 may be a low latency PPDU. As shown, the AP 102 waits to transmit the low latency downlink packet until the second TXOP 508, which may delay transmission of the low latency packet. The time to transmit the low latency packet may be reduced by shortening PPDUs. For example, the AP 102 may use EDCA parameters, such as MU EDCA parameters, and may control TXOP limits for examples where the AP is not the TXOP holder. As another example, the AP 102 may use other potential EDCA parameter set variants.

In the second example TXOP timing diagram 504, the AP 102 may be the TXOP holder for the first TXOP 506. The AP 102 may transmit a long downlink PPDU 510 in the first TXOP 506. The STA 104 which receives the long downlink PPDU 510 may transmit an acknowledgment 512 for the long downlink PPDU 510 within the first TXOP 506. During transmission of the long downlink PPDU 510, a new uplink low latency packet may arrive at the STA 104 for transmission to the AP 102 (labeled in diagram 504 as “UL Low Lat Traffic Arrives”). The STA 104 waits until a second TXOP 518 assigned to the STA 104 to transmit the uplink low latency packet in a PPDU 520. The AP 102 may transmit an acknowledgment 522 for the PPDU 520 within the second TXOP 518. The second TXOP 518 may be a low latency TXOP and the PPDU 520 may be a low latency PPDU (labeled in diagram 502 as “Low Lat PPDU”). As shown, the STA 104 waits to transmit the low latency uplink packet until the second TXOP 518, which may delay transmission of the low latency packet. Techniques described herein may be used to reduce the waiting time to transmit low latency uplink and downlink packets for devices during a TXOP. For example, a device that is not the TXOP holder may use described techniques to transmit low latency traffic that arrives during the TXOP, or a TXOP-holder may use described techniques to transmit low latency traffic that arrives a the TXOP-holder during the TXOP.

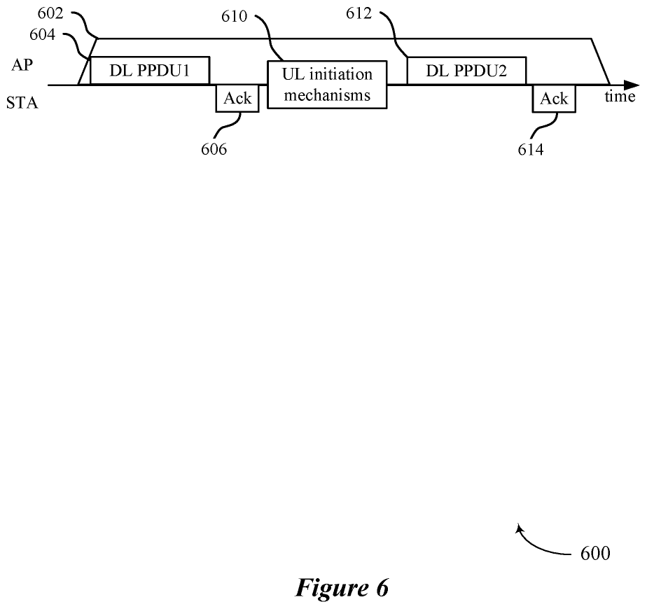

FIG. 6 shows an example of a downlink TXOP timing diagram with mechanisms to trigger uplink transmissions 600 that supports low latency channel access. The downlink TXOP timing diagram with mechanisms to trigger uplink transmissions 600 may implement or may be implemented by aspects of the wireless communication network 100.

As shown in FIG. 6, a downlink TXOP 602 may be assigned to an AP 102. Multiple short PPDUs (such as a first downlink PPDU 604, labeled as “DL PPDU1” in FIG. 6, and a second downlink PPDU 612, labeled as “DL PPDU2” in FIG. 6) may be scheduled in the downlink TXOP 602. A STA 104 may receive the first downlink PPDU 604 and transmit an acknowledgment 606 for the first downlink PPDU 604 within the downlink TXOP 602 and/or the STA 104 may receive the second downlink PPDU 612 and transmit an acknowledgment 614 for the first downlink PPDU 604 within the downlink TXOP 602. The AP 102 and the STA 104 may perform uplink initiation mechanisms 610 (labeled as “UL initiation mechanisms”) in the interframe space between the first downlink PPDU 604 and the second downlink PPDU 612, for example, if the STA 104 identifies low latency uplink traffic for transmission within the downlink TXOP 602. For example, the STA 104 may transmit a preemption indication to preempt the second downlink PPDU 612. In some examples, the first downlink PPDU 604 may include an indication that preemption is allowed or enabled. In some examples, preemption may be dynamically enabled and disabled through UHR management signaling.

Preemption within a TXOP as described herein may improve WLAN reliability in terms of latency by allowing low latency devices with event-driven low latency traffic (such as APs 102 or STAs 104) to preempt the existing TXOP obtained by another TXOP holder (such as based on a preemption allowed or enabled indication from the TXOP holder) and access the transmission medium earlier in order to transmit the low latency traffic. At a high level, preemption approaches may involve the TXOP holder (such as an AP 102 or a STA 104) using short PPDUs with interframe space separation (such as PIFS or SIFS) between the PPDUs to allow devices with low latency traffic to access the channel within the TXOP and avoid additional contention with other devices. Preemption approaches may be scalable and may allow several low latency STAs 104 to benefit from low latency channel access without incurring high complexity and while avoiding increased collisions between overlapping BSSs. Preemption indication allowability by the TXOP holder may occur early in the PPDU, and a preemption indication or request by a device with low latency traffic to transmit may be as simple as an indication of the presence of pending low latency traffic.

Some examples of preemption within a TXOP may be trigger-based. For example, 802.11ax introduced uplink OFDMA-based random backoff (UORA) for trigger-based random access and Null Data Packed (NDP) Feedback Report Polls (NFRP)/NDP Feedback Reports (NFRs) and Buffer Status Report Poll (BSRP)/Buffer Status Reports (BSRs) to collect feedback. UORA, NFRP/NFR, or BSRP/BSR techniques may be used for trigger-based preemption of transmissions with a TXOP. UORA may result in transmissions from client devices colliding on RUs and AP and uncertainty regarding the quantity of RUs to schedule without aperiodic client traffic. In some examples, the TXOP-holder (e.g., the AP 102) may use interframe space separated short PPDUs and may transmit a preemption allowed indication. Based on the preemption allowed indication, non-TXOP-holder devices that have low latency traffic to transmit, such as STAs 104, may transmit preemption indications to the TXOP-holder. In response to the preemption indications, the TXOP-holder may transmit a trigger frame (e.g., an NFRP, a BSRP, or a basic trigger frame) and may either trigger the non-TXOP-holder devices to transmit the low latency data directly or may allocate random RUs that may be reserved by the non-TXOP-holder devices.

In some examples, a STA 104 with low latency traffic may inform the AP 102 of traffic requirements of the STA 104 that require preemption support from the AP 102. The TXOP-holder (for example, the AP 102), may set a preemption allowed bit in a PPDU transmitted by the TXOP-holder to “1” to enable or allow preemption. The STA 104 with low latency traffic may inform the AP 102 of additional parameters such as average interpacket/burst arrival or data rate through a management frame such as a stream classification service (SCS) request response.

In some examples, a client device such as a STA 104 may not be able to set up a block acknowledgment to send multiple MPDUs before preempting the AP 102, and therefore the STA 104 may be allowed to transmit multiple PPDUs within a specified limit toward the AP 102.

In some examples, client device such as a STA 104 may be allowed to send a preemption indication to the TXOP-holder without contending for medium access based on regulatory rules that allow short packets to be transmitted.

Some examples of preemption within a TXOP may be EDCA-based. EDCA-based approaches may use SU transmissions, which may be defined in UHR. In EDCA-based approaches, the client device may select the transmission parameters based on the buffered event-driven low latency traffic.

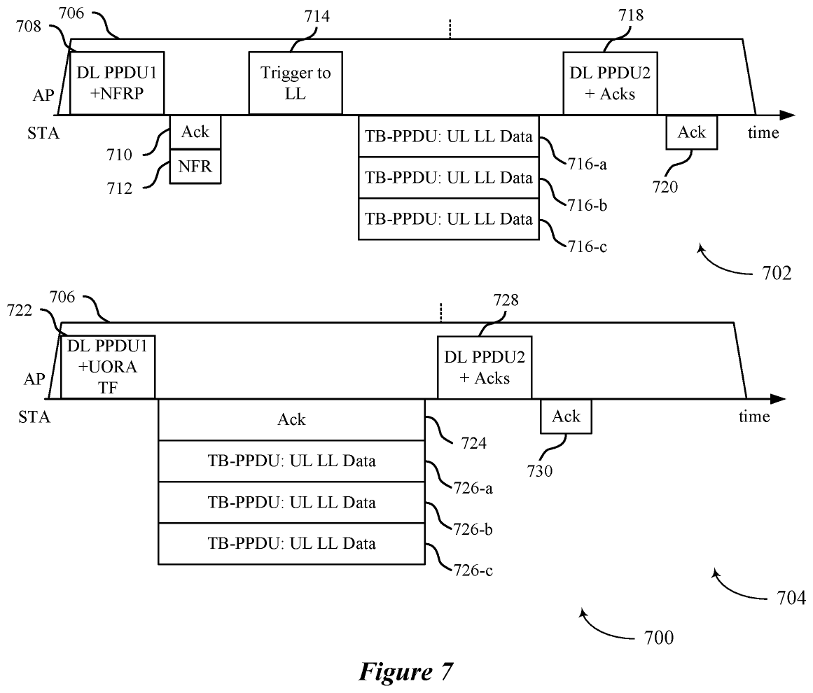

FIG. 7 shows an example of a downlink TXOP timing diagram 700 with trigger-based preemption of transmissions within a TXOP that supports low latency channel access. The downlink TXOP timing diagram 700 with trigger-based preemption of transmissions within a TXOP may implement or may be implemented by aspects of the wireless communication network 100.

A first example TXOP timing diagram 702 shows an example that implements NFRP-based trigger-based preemption of transmissions for a TXOP 706 assigned to an AP 102. A second example TXOP timing diagram 704 shows an example that implements UORA-based trigger-based preemption of transmissions for a TXOP 706 assigned to the AP 102.

In the first example TXOP timing diagram 702, the AP 102 may transmit a first downlink PPDU 708 that also includes an NFRP (labeled as “DL PPDU1+NFRP” in diagram 702). In response to the first downlink PPDU 708, STAs 104 that receive the first downlink PPDU 708 may transmit an acknowledgment 710 for the first downlink PPDU 708. Any STA 104 that has low latency data to transmit also may transmit an NFR 712 that indicates the STA has low latency data to transmit. In response to the NFR(s) 712, the AP 102 may transmit a trigger frame 714 that indicates for the STAs 104 and/or may indicate resources for the STAs 104 to transmit the uplink low latency data within the TXOP 706. The STA(s) 104 may transmit trigger-based PPDUs 716 that include the respective uplink low latency data (labeled as “TB-PPDU: UL LL Data”) triggered by the trigger frame 714. For example, if three STAs 104 transmitted NFRs 712, a first STA 104 may transmit a trigger-based PPDU 716-a, a second STA 104 may transmit a trigger-based PPDU 716-b, and a third STA 104 may transmit a trigger-based PPDU 716-c. The AP 102 may subsequently transmit a second downlink PPDU 718. The STA(s) 104 that receive the second downlink PPDU 718 may transmit an acknowledgment 720 for the second downlink PPDU 718.

In the second example TXOP timing diagram 704, the AP 102 may transmit a first downlink PPDU 722 that also includes a UORA trigger frame (labeled as “DL PPDU1+UORA TF” in FIG. 7). The UORA trigger frame may indicate resources for the STAs 104 to transmit the uplink low latency data within the TXOP 706. In response to the first downlink PPDU 722, STA(s) 104 that receive the first downlink PPDU 722 may transmit an acknowledgment 724 for the first downlink PPDU 722. Based on the UORA trigger frame in the first downlink PPDU 722, the STA(s) 104 that have low latency data to transmit may transmit trigger-based PPDUs 726 that include the respective uplink low latency data triggered by the UORA trigger frame. For example, if three STAs 104 have uplink low latency data to transmit, a first STA 104 may transmit a trigger-based PPDU 726-a, a second STA 104 may transmit a trigger-based PPDU 726-b, and a third STA 104 may transmit a trigger-based PPDU 726-c. The AP 102 may subsequently transmit a second downlink PPDU 728. The STA(s) 104 that receive the second downlink PPDU 728 may transmit an acknowledgment 730 for the second downlink PPDU 728.

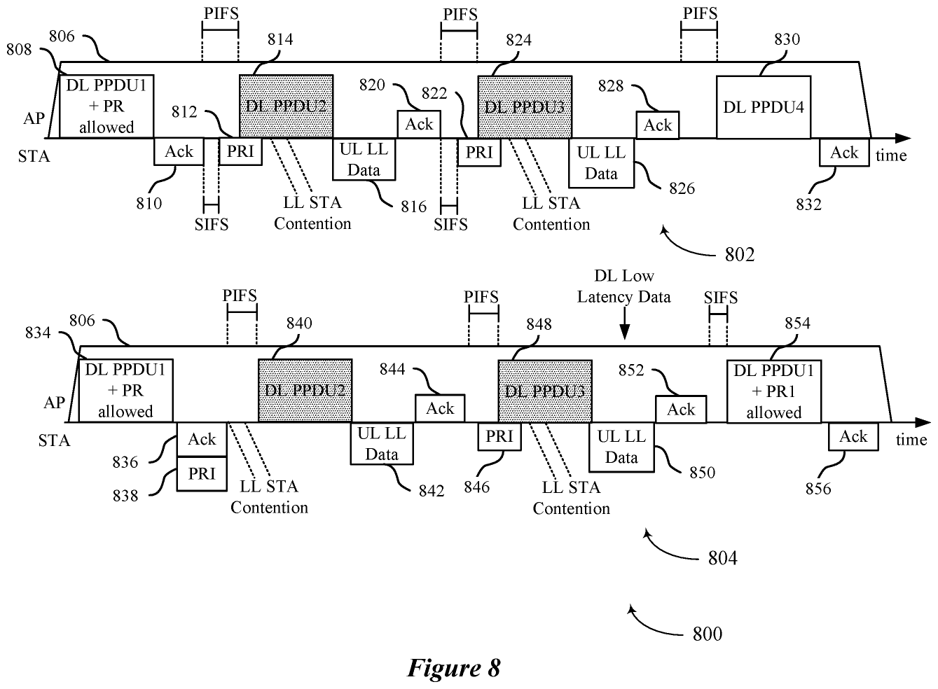

FIG. 8 shows an example of a downlink TXOP timing diagram 800 with EDCA-based preemption of transmissions within a TXOP that supports low latency channel access. The downlink TXOP timing diagram 800 with EDCA-based preemption of transmissions within a TXOP may implement or may be implemented by aspects of the wireless communication network 100.

A first example TXOP timing diagram 802 shows an example where a STA 104 transmits a preemption indication within a TXOP 806 assigned to an AP 102 after an acknowledgment to a downlink PPDU 808 from the AP 102. For example, FIG. 8 illustrates that the AP 102 may transmit a first downlink PPDU 808 that includes an indication that preemption within the TXOP 806 is allowed (labeled as “DL PPDU+PR allowed” in FIG. 8). STA(s) 104 that receive the downlink PPDU 808 may transmit an acknowledgment 810 to the downlink PPDU 808. STA(s) 104 that have uplink low latency data to transmit may transmit a preemption indication 812 a time period (such as a SIFS) after the acknowledgment 810. In some examples, the preemption indication 812 may be a clear to send (CTS) frame. In some examples, the preemption indication 812 may be a null data packet (e.g., may have a PHY header only). The preemption indication(s) 812 may preempt a downlink PPDU 814 (labeled as “DL PPDU2” in FIG. 8), and accordingly the AP 102 may drop (such as refrain from transmitting) the downlink PPDU 814 in response to receiving the preemption indication(s) 812. The STAs 104 that transmit preemption indications 812 may contend to send low latency uplink data (labeled as “LL STA Contention” in FIG. 8). A STA 104 that succeeds in the contention may transmit an uplink PPDU 816 that includes uplink low latency data (labeled as “UL LL Data” in FIG. 8). The AP 104 may transmit an acknowledgment 820 to reception of the uplink PPDU 816. In some examples, the STA(s) may not transmit the acknowledgment 810 and may only transmit the preemption indication 812.

In some examples, the acknowledgment 820 may include an indication that preemption within the TXOP 806 is allowed. STA(s) 104 that receive the acknowledgment 820 that indicates preemption is allowed and that have uplink low latency data to transmit may transmit a preemption indication 822 after a time period (such as a SIFS) after the acknowledgment 820. The preemption indication(s) 822 may preempt a third downlink PPDU 824 (labeled as “DL PPDU3” in FIG. 8), and accordingly the AP 102 may drop (such as refrain from transmitting) the third downlink PPDU 824 in response to receiving the preemption indication(s) 822. The STAs 104 that transmit preemption indications 812 may contend to send low latency uplink data (labeled as “LL STA Contention” in FIG. 8), such as during transmission of the third downlink 824 from the AP 102. A STA 104 that succeeds in the contention may transmit an uplink PPDU 826 that includes uplink low latency data (labeled as “UL LL Data” in FIG. 8). The AP 104 may transmit an acknowledgment 828 to reception of the uplink PPDU 816.

In some examples, the acknowledgment 828 may include an indication that preemption within the TXOP 806 is allowed. If no STA 104 transmits a preemption indication within a period of time (such as within a PIFS) the AP 102 may transmit a fourth downlink PPDU 830 (labeled as “DL PPDU4” in FIG. 8). STA(s) 104 that receive the fourth downlink PPDU 830 may transmit an acknowledgment 832 to the fourth downlink PPDU 830. In some examples, the uplink PPDU 816 and the uplink PPDU 826 may be SU PPDUs.

A second example TXOP timing diagram 804 shows an example where a STA 104 transmits a preemption indication with an acknowledgment to a downlink PPDU. For example, FIG. 8 illustrates that the AP 102 may transmit a first downlink PPDU 834 that includes an indication that preemption within the TXOP 806 is allowed (labeled as “DL PPDU+PR allowed” in FIG. 8). STA(s) 104 that receive the downlink PPDU 834 may transmit an acknowledgment 836 to the downlink PPDU 808. STA(s) 104 that have uplink low latency data to transmit may transmit a preemption indication 838 with the acknowledgment 836. For example, the AP 102 may just allocate one RU for any of the low latency clients to indicate the preemption indication 838. In some examples, the preemption indication 838 may be a CTS frame. The preemption indication(s) 838 may preempt a second downlink PPDU 840 (labeled as “DL PPDU2” in FIG. 8), and accordingly the AP 102 may drop (such as refrain from transmitting) the second downlink PPDU 840 in response to receiving the preemption indication(s) 838. The STAs 104 that transmit preemption indications 838 may contend (labeled as “LL STA Contention” in FIG. 8) to send low latency uplink data. A STA 104 that succeeds in the contention may transmit an uplink PPDU 842 that includes uplink low latency data (labeled as “UL LL Data” in FIG. 8). The AP 102 may transmit an acknowledgment 844 to reception of the uplink PPDU 842.

In some examples, the acknowledgment 844 may include an indication that preemption within the TXOP 806 is allowed. STA(s) 104 that receive the acknowledgment 844 that indicates preemption is allowed and that have uplink low latency data to transmit may transmit a preemption indication 846 after the acknowledgment 844. The preemption indication(s) 846 may preempt a third downlink PPDU 848 (labeled as “DL PPDU3” in FIG. 8), and accordingly the AP 102 may drop (such as refrain from transmitting) the third downlink PPDU 848 in response to receiving the preemption indication(s) 846. The STAs 104 that transmit preemption indications 846 may contend to send low latency uplink data. A STA 104 that succeeds in the contention may transmit an uplink PPDU 850 that includes uplink low latency data labeled as “UL LL Data” in FIG. 8). The AP 104 may transmit an acknowledgment 852 to reception of the uplink PPDU 850.

Downlink low latency traffic may arrive at the AP 102 prior to transmission of the acknowledgment 852, and accordingly the AP 102 may not include an indication that preemption within the TXOP 806 is allowed in the acknowledgment 852. The AP 102 may transmit a fourth downlink PPDU 854 (labeled as “DL PPDU4” in FIG. 8). STA(s) 104 that receive the fourth downlink PPDU 854 may transmit an acknowledgment 856 to the fourth downlink PPDU 854. In some examples, the uplink PPDU 842 and the uplink PPDU 850 may be SU PPDUs.

As shown, in EDCA-based preemption of transmissions with a TXOP, the AP 102 may initiate preemption of transmissions with a TXOP to help client devices (such as STAs 104) to access the communication medium for sending uplink SU PPDUs within the TXOP 806 of the AP 102. AP initiation of preemption of transmissions with a TXOP may be used because the AP announcement that preemption is allowed may be received by various STAs 104 in the BSS and may reduce contention with downlink access for low latency data. SU PPDUs may be used to help client devices (such as STAs 104) to optimize transmission parameters (such as MCS, number of spatial streams (NSS), or bandwidth) and to flush the low latency traffic within the EDCA grant.

As shown in both the first example TXOP timing diagram 802 and the second example TXOP timing diagram 804, the AP 102 may initiate EDCA based preemption of transmissions with a TXOP by transmitting a PPDU (such as the downlink PPDU 808 or the downlink PPDU 834) that carries a preemption allowed indication and the grant duration (such as the grant duration for the uplink PPDU 816 or the uplink PPDU 842). In some examples, the grant duration may begin after the STA 104 transmit the preemption indication 812. In some examples, the preemption allowed indication may be included in a PHY header of the PPDU (such as the downlink PPDU 808 or the downlink PPDU 834) or may be included in a special receiver address in a (short) control frame to reduce signaling overhead. In some examples, the AP 102 may initiate the EDCA based preemption of transmissions with a TXOP on a PPDU basis, which may help the AP 102 to deliver event-based downlink low latency packets that may arrive within the TXOP 806. In some examples, the AP 102 may initiate the EDCA based preemption of transmissions with a TXOP on a TXOP basis (such as the preemption allowed indication may indicate that preemption is allowed for the entirety of the TXOP 806).

As shown in the first example TXOP timing diagram 802, in some examples, the AP 102 may wait for a PIFS duration after the downlink PPDU 808 and the response frame (the acknowledgment 810) before scheduling another downlink PPDU 814 so that a STA 104 with low latency traffic may transmit a preemption indication 812 within a SIFs duration following the downlink PPDU 808 and the response frame (the acknowledgment 810), enabling the STA 104 to check the acknowledgment policy and the L-SIG duration or the TXOP duration. In some examples, the preemption indication 812 may be a CTS frame transmitted in a SIFS frame following the downlink PPDU 808 and the response frame (the acknowledgment 810) such that the AP 102 may defer transmission of the downlink PPDU 814 after a PIFS.

In some examples, the STA 104 may complete the transmission of the uplink PPDU 816 before the end of the grant (e.g., indicated in the preemption allowed indication). In such cases, the STA 104 may transmit a control signal to indicate return of the TXOP back to the AP 102 (e.g., the control signal may be a PHY header or frame, a MAC header such as A-control, or a MAC frame).

In some examples, a STA 104 may receive the preemption allowed indication in the downlink PPDU 808. The STA 104 may not detect the acknowledgment 810 or block acknowledgment after the downlink PPDU 808, for example, where an Ack policy in the downlink PPDU 808 requires an Ack, and where the STA 104 is hidden to the STA 104 that transmits the acknowledgment 810 or block acknowledgment. In such cases, rules may be defined that require the STA 104 that does not detect the acknowledgment 810 or block acknowledgment after the downlink PPDU 808 to not send a preemption indication (e.g., a SIFs after the acknowledgment 810 or block acknowledgment) and hence, the STA 104 that does not detect the acknowledgment 810 or block acknowledgment after the downlink PPDU 808 may not be allowed to preempt the TXOP 806. In some examples, a timeout duration may be defined for after reception of the downlink PPDU 808 after which timeout duration the STA 104 that does not detect the acknowledgment 810 or block acknowledgment after the downlink PPDU 808 may transmit a preemption indication 812 or may start contending for access to the channel.

As shown in the second example TXOP timing diagram 804, in some examples, the AP 102 may allocate a broadcast RU (such as may define a specific association ID for STAs 104) in the downlink PPDU 834 (which may be a downlink multiuser PPDU). The broadcast RU may be used by STAs 104 to transmit the preemption indication 838 on top of a response frame (the acknowledgment 836) in order to indicate the presence of low latency traffic. In some examples, the acknowledgment may be a block acknowledgment, and the STA 104 that transmits the block acknowledgment may support triggered response scheduling (TRS).

The preemption allowed indication transmitted by the AP 102 (such as in the downlink PPDU 808, the acknowledgment 820, the acknowledgment 828, the downlink PPDU 834, and the acknowledgment 844) may enable the AP 102 to identify if there is any device that has pending low latency data within a PIFS duration following the PPDU or acknowledgment carrying the preemption allowed indication, which may reduce unnecessary overhead and complexity that may result from separate trigger frames (such as in NFRP/NFR or BSRP/BSR trigger-based schemes). After receiving a preemption allowed indication, low latency STAs 104 may transmit a preemption indication (such as the preemption indication 812, the preemption indication 822, the preemption indication 838, or the preemption indication 846) to indicate the low latency STAs have pending low latency traffic. Following the preemption indication(s) by STA(s) 104, STAs 104 may contend to transmit the low latency traffic by ignoring NAV set by the AP in previous frames (such as the AP may use multiple protection settings).

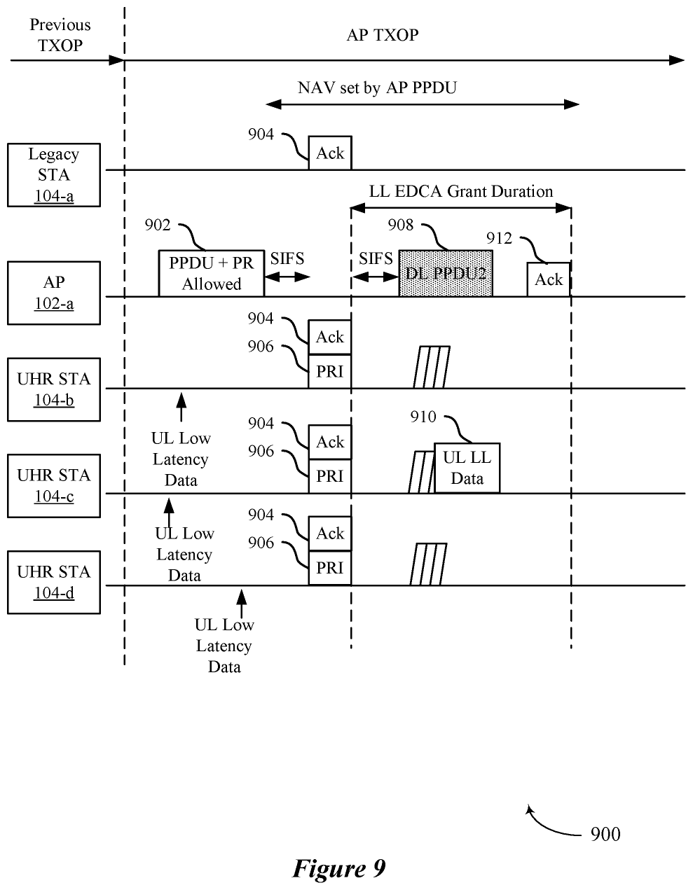

FIG. 9 shows an example of a timing diagram 900 for a low latency EDCA grant during a downlink TXOP with immediate backoff that supports low latency channel access. The timing diagram 900 may implement or may be implemented by aspects of the wireless communication network 100. For example, the timing diagram 900 may include an AP 102-a, which may be an example of an AP 102 as described herein. The timing diagram 900 may include a legacy STA 104-a, a first UHR STA 104-b, a second UHR STA 104-c, and a third UHR STA 104-d, which may be examples of STAs 104 as described herein. The legacy STA 104-a may not be capable of preempting a TXOP assigned to the AP 102-a.

A NAV may be set by the AP 102-a in a previous TXOP. In the current AP TXOP, the AP 102-a may transmit a PPDU 902 (labeled as “PPDU+PR Allowed” in FIG. 9) which includes an indication that preemption is allowed. After a SIFS period, the legacy STA 104-a may transmit an acknowledgment 904 for the PPDU 902. Low latency traffic may arrive at each of the first UHR STA 104-b, the second UHR STA 104-c, and the third UHR STA 104-d during transmission of the PPDU 902 or during the SIFs after the PPDU 902. Accordingly, the first UHR STA 104-b, the second UHR STA 104-c, and the third UHR STA 104-d may each transmit an acknowledgment 904 for the PPDU 902 and a preemption indication 906 announcing the presence of low latency traffic for transmission. In response to reception of the preemption indications 906, the AP 102-a may postpone or cancel transmission of the second downlink PPDU 908 (labeled as “DL PPDU2” in FIG. 9) in the AP TXOP, which may have been scheduled for transmission after a SIFS duration after the acknowledgment 904.

The first UHR STA 104-b, the second UHR STA 104-c, and the third UHR STA 104-d may contend for channel access (for example, may perform a random backoff), and based on the random backoff, the second UHR STA 104-c may transmit an uplink PPDU 910 (labeled as “UL LL Data” in FIG. 9) which transmits the low latency data for the second UHR STA 104-c. The AP 102-a may transmit an acknowledgment 912 for the uplink PPDU 910. The EDCA grant duration between the preemption indication 906 and the acknowledgment 912 may be indicated by the AP 102-a in the PPDU 902.

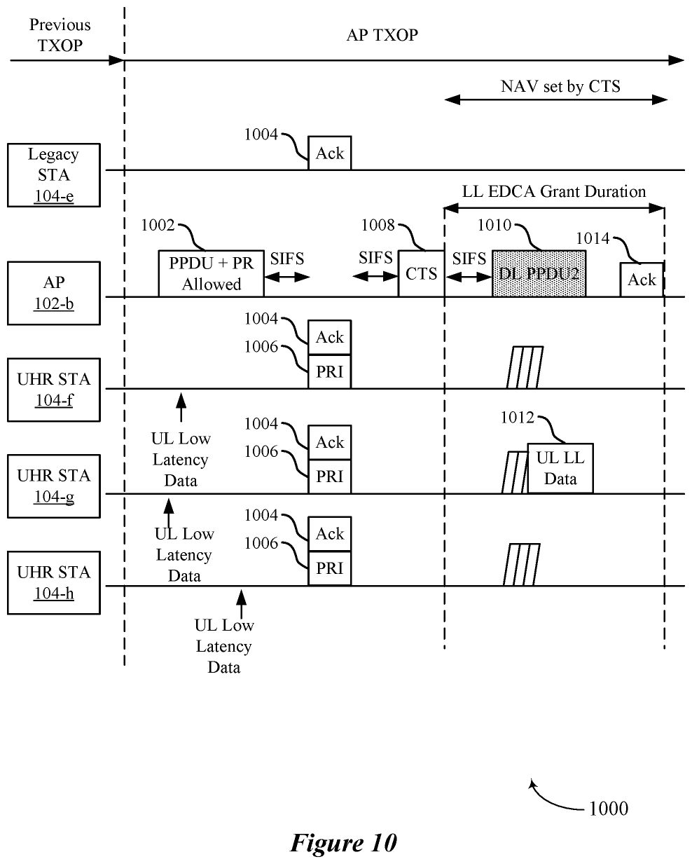

FIG. 10 shows an example of a timing diagram 1000 for a low latency EDCA grant during a downlink TXOP with immediate backoff that supports low latency channel access. The timing diagram 1000 may implement or may be implemented by aspects of the wireless communication network 100. For example, the timing diagram 1000 may include an AP 102-b, which may be an example of an AP 102 as described herein. The timing diagram 1000 may include a legacy STA 104-c, a first UHR STA 104-f, a second UHR STA 104-g, and a third UHR STA 104-h, which may be examples of STAs 104 as described herein. The legacy STA 104-e may not be capable of preempting a TXOP assigned to the AP 102-b.

A NAV may be set by the AP 102-b in a previous TXOP. In the current AP TXOP, the AP 102-b may transmit a PPDU 1002 (labeled as “PPDU+PR Allowed” in FIG. 10) which includes an indication that preemption is allowed. After a SIFS period, the legacy STA 104-c may transmit an acknowledgment 1004 for the PPDU 1002. Low latency traffic may arrive at each of the first UHR STA 104-f, the second UHR STA 104-g, and the third UHR STA 104-h during transmission of the PPDU 1002 or during the SIFs after the PPDU 1002. Accordingly, the first UHR STA 104-f, the second UHR STA 104-g, and the third UHR STA 104-h may each transmit an acknowledgment 1004 for the PPDU 1002 and a preemption indication 1006 announcing the presence of low latency traffic for transmission. In response to reception of the preemption indications 1006, the AP 102-b may transmit a CTS frame 1008 which may indicate that the AP 102-b has postponed or canceled transmission of the second downlink PPDU 1010 (labeled as “DL PPDU2” in FIG. 10) in the AP TXOP.

The first UHR STA 104-f, the second UHR STA 104-g, and the third UHR STA 104-h may contend for channel access (for example, may perform a random backoff), and based on the random backoff, the second UHR STA 104-g may transmit an uplink PPDU 1012 (labeled as “UL LL Data” in FIG. 10) which transmits the low latency data for the second UHR STA 104-g. The AP 102-b may transmit an acknowledgment 1014 for the uplink PPDU 1012. The EDCA grant duration between the CTS frame 1008 and the acknowledgment 1014 may be indicated by the AP 102-b in the PPDU 902.

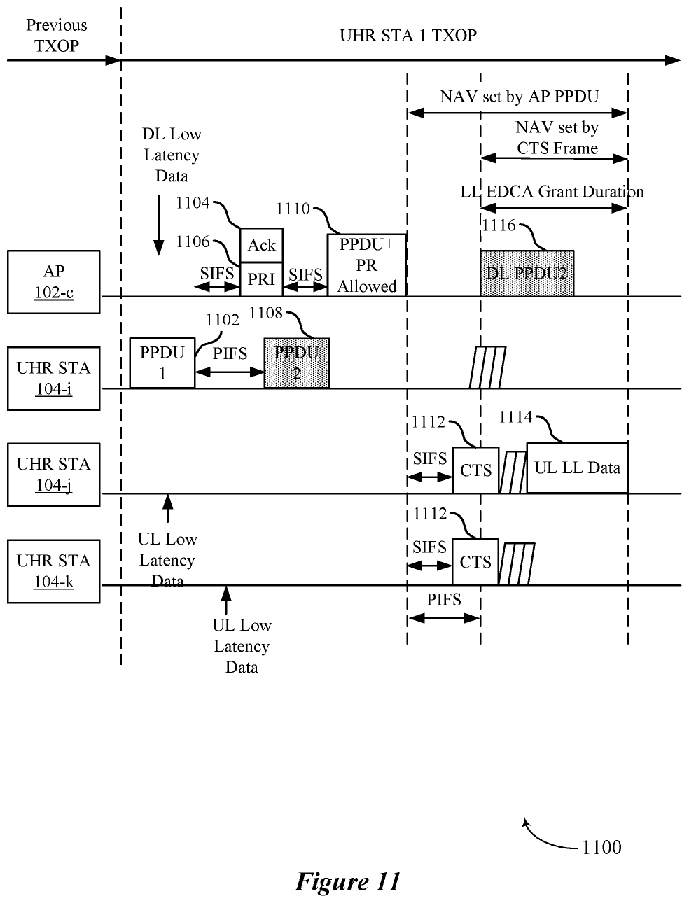

FIG. 11 shows an example of a timing diagram 1100 for a low latency EDCA grant during an uplink TXOP that supports low latency channel access. The timing diagram 1100 may implement or may be implemented by aspects of the wireless communication network 100. For example, the timing diagram 1000 may include an AP 102-c, which may be an example of an AP 102 as described herein. The timing diagram 1000 may include a first UHR STA 104-i, a second UHR STA 104-j, and a third UHR STA 104-k, which may be examples of STAs 104 as described herein. In the timing diagram 1100, the TXOP may be assigned to the first UHR STA 104-i.

A NAV may be set by the AP 102-b in a previous TXOP. The first UHR STA 104-i may transmit an uplink PPDU 1102 (labeled as “PPDU 1” in FIG. 11) to the AP 102-c. The uplink PPDU 1102 may include an indication that preemption is allowed. After a SIFS duration, the AP 102-c may transmit an acknowledgment 1104 for the uplink PPDU 1102. Downlink low latency traffic may arrive at the AP 102-c during the uplink PPDU 1102 or during the SIFs period after the uplink PPDU 1102. Accordingly, the AP 102-c may transmit a preemption indication 1106 with the acknowledgment 1104. The preemption indication 1106 may indicate for the first UHR STA 104-b to postpone or cancel transmission of a second uplink PPDU 1108 (labeled as “PPDU 2” in FIG. 11). After a SIFS duration after the preemption indication 1106, the AP 102-c may transmit a downlink PPDU 1110 (labeled as “PPDU+PR Allowed” in FIG. 11) that includes the downlink low latency traffic.

In some examples, the downlink PPDU 1110 may include an indication that preemption is allowed. Uplink low latency traffic may arrive at the second UHR STA 104-j and the third UHR STA 104-k prior to transmission of the downlink PPDU 1110. A SIFS period after the transmission of the downlink PPDU 1110, the second UHR STA 104-j and the third UHR STA 104-k may transmit CTS frames 1112 using a resource indicated by the AP 102-c (such as in the downlink PPDU 1110), where the CTS frames 1112 may announce that the second UHR STA 104-j and the third UHR STA 104-k have uplink low latency traffic to transmit. Reception of the CTS frames 1112 may cause the AP 102-c to cancel or postpone a downlink PPDU 1116 (labeled as “DL PPDU2” in FIG. 11). The second UHR STA 104-j and the third UHR STA 104-k may contend to send low latency uplink data, and the second UHR STA 104-j may succeed in the contention. Accordingly, the second UHR STA 104-j may transmit an uplink PPDU 1114 (labeled as “UL LL Data” in FIG. 11). A EDCA grant period may be equal to a NAV set by the CTS frames 1112, and may extend from a PIFS duration after the downlink PPDU 1110 to the end of the uplink PPDU 1114.

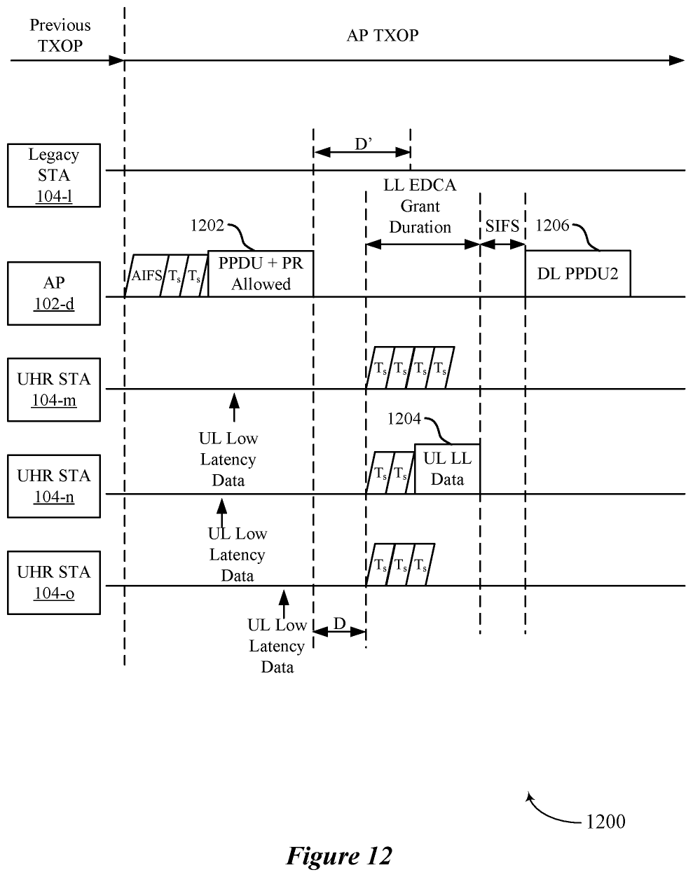

FIG. 12 shows an example of a timing diagram 1200 for a low latency EDCA grant during a downlink TXOP that supports low latency channel access. The timing diagram 1200 may implement or may be implemented by aspects of the wireless communication network 100. For example, the timing diagram 1200 may include an AP 102-d, which may be an example of an AP 102 as described herein. The timing diagram 1200 may include a legacy STA 104-1, a first UHR STA 104-m, a second UHR STA 104-n, and a third UHR STA 104-0, which may be examples of STAs 104 as described herein.

In some examples, low latency devices (such as APs 102 or STAs 104) may access the transmission medium during a TXOP assigned to another device using sub-slot granularity. For example, slots may be defined as 9 microseconds, and a sub-slot may be 4 microseconds. Sub-slot granular countdown may reduce collisions within the low latency devices (such as within a PIDS separated burst by the AP 102) and may still prioritize access over legacy STAs 104. In some examples, the AP 102 may use a multi-cast solicitation mechanism to determine if the AP 102 should send a low latency EDCA grant. The solicitation may be signaling such as a low latency multiuser RTS or CTS or equivalent. The purpose of the solicitation may be to determine if any device has pending low latency data.

With reference to FIG. 12, after an Arbitration inter-frame spacing (AIFS) and one or more time periods Tₛ, the AP 102-d may initiate a low latency EDCA grant via transmission of a PPDU 1202 that carries a preemption allowed indication (labeled as “PPDU+PR Allowed” in FIG. 12). In some examples, the PPDU 1202 may indicate the low latency EDCA grant duration. The preemption allowed indication may be included in a PHY header or in a MAC header frame (such as may be piggybacked in the PPDU 1202 or may be in a short control frame such as a CTS or RTS with a special receiver address) to reduce overhead.

Uplink low latency traffic may arrive at the first UHR STA 104-m, the second UHR STA 104-n, and the third UHR STA 104-o prior to the end of the transmission of the PPDU 1202. The first UHR STA 104-m, the second UHR STA 104-n, and the third UHR STA 104-o may begin contending after the end of the PPDU 1202 (such as immediately after the PPDU 1202 or a SIFS duration after). For example, a delay D may be a delay to start contending between the first UHR STA 104-m, the second UHR STA 104-n, and the third UHR STA 104-0, and the contention granularity may be based on time periods Tₛ, which may be sub-slots. A delay D′ may be a time duration during which the legacy STA 104-1 cannot access the channel (such as PIFS bursting or NAV/CTS timeout or the NAV duration). As shown, the second UHR STA 104-n may succeed in the contention and transmit an uplink PPDU 1204 (labeled as “UL LL Data” in FIG. 12) that carries low latency traffic within the low latency EDCA grant duration. The AP 102-d may transmit a second downlink PPDU 1206 (labeled as “DL PPDU2” in FIG. 12) after a SIFS duration after the low latency EDCA grant duration.

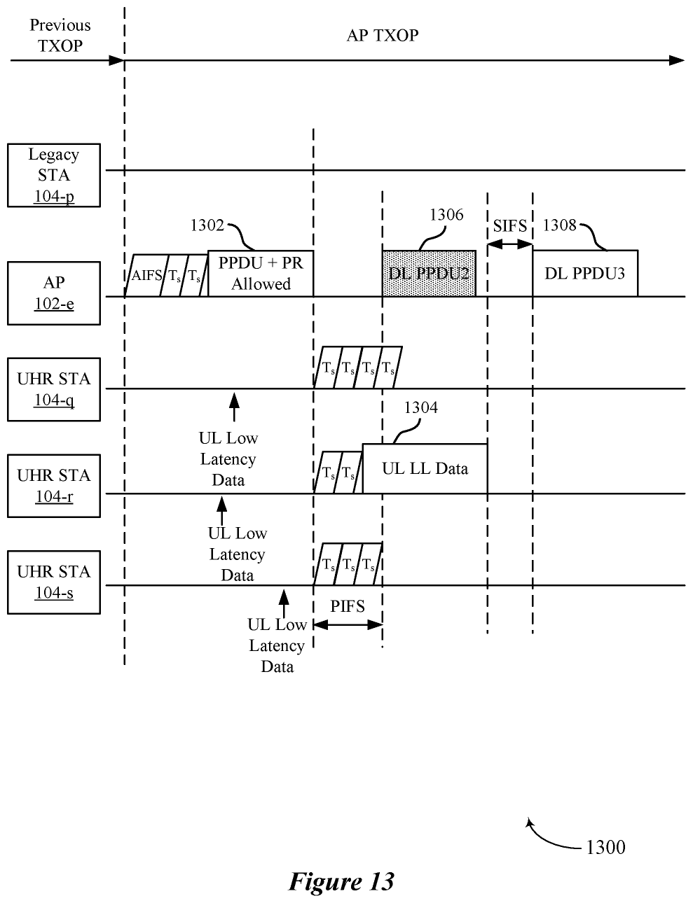

FIG. 13 shows an example of a timing diagram 1300 for a low latency EDCA grant during a downlink TXOP that uses sub-slot granularity that supports low latency channel access. The timing diagram 1300 may implement or may be implemented by aspects of the wireless communication network 100. For example, the timing diagram 1300 may include an AP 102-e, which may be an example of an AP 102 as described herein. The timing diagram 1300 may include a legacy STA 104-p, a first UHR STA 104-q, a second UHR STA 104-r, and a third UHR STA 104-s, which may be examples of STAs 104 as described herein.

After an AIFS duration and one or more sub-slots Tₛ, the AP 102-d may initiate a low latency EDCA grant via transmission of a PPDU 1302 that carries a preemption allowed indication (labeled as “PPDU+PR Allowed” in FIG. 13). In some examples, the PPDU 1302 may indicate the low latency EDCA grant duration. The preemption allowed indication may be included in a PHY header or in a MAC header frame (such as may be piggybacked in the PPDU 1302 or may be in a short control frame such as a CTS or RTS with a special receiver address) to reduce overhead.

Uplink low latency traffic may arrive at the first UHR STA 104-q, the second UHR STA 104-r, and the third UHR STA 104-s prior to the end of the transmission of the PPDU 1202. The first UHR STA 104-q, the second UHR STA 104-r, and the third UHR STA 104-s may begin contending after the end of the PPDU 1302 (such as immediately after the PPDU 1302 or after a SIFS duration). The contention granularity may be based on sub-slots Tₛ (such as 4 microseconds). As shown, the second UHR STA 104-r may succeed in the contention and transmit an uplink PPDU 1304 (labeled as “UL LL Data” in FIG. 13) that carries low latency traffic within the low latency EDCA grant duration. Transmission of the uplink PPDU 1304 may preempt a downlink PPDU 1306 (labeled as “DL PPDU2” in FIG. 12) scheduled after a PIFS duration after the PPDU 1302. The AP 102-d may transmit a downlink PPDU 1308 (labeled as “DL PPDU3” in FIG. 12) after a SIFS duration after the end of the uplink PPDU 1304.

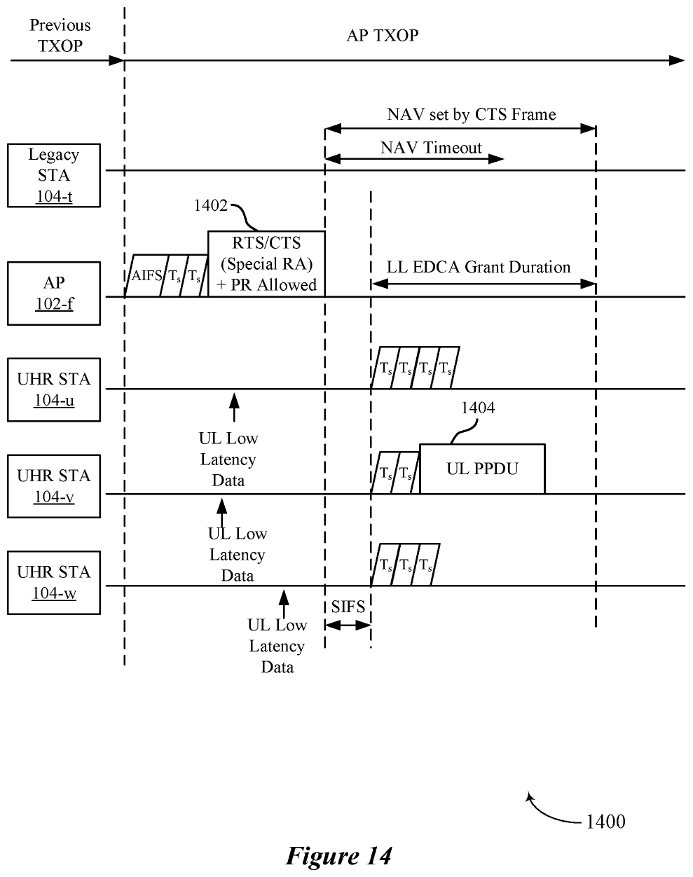

FIG. 14 shows an example of a timing diagram 1400 for a low latency EDCA grant during a downlink TXOP that supports low latency channel access. The timing diagram 1400 may implement or may be implemented by aspects of the wireless communication network 100. For example, the timing diagram 1400 may include an AP 102-f, which may be an example of an AP 102 as described herein. The timing diagram 1400 may include a legacy STA 104-t, a first UHR STA 104-u, a second UHR

STA 104-v, and a third UHR STA 104-w, which may be examples of STAs 104 as described herein.

After an AIFS and one or more time periods Tₛ, the AP 102-g may transmit a frame 1402 that includes a preemption allowed indication (labeled as “RTS/CTS (Special RA)+PR Allowed” in FIG. 14).

In some examples, the frame 1402 may be an RTS frame with a special receiver address as the preemption allowed indication allowed. A NAV timeout may be around 100 microseconds (such as NAV timeout=(2×aSIFStime)+(CTS_Time)+(aR×PHYStartDelay)+(2×aSlotTime)) which may allow for a maximum of 10 random time slots (9 microsecond slots) to be used by the contending STAs 104.

In some examples, the frame 1402 may be a CTS frame with a special receiver address as the preemption allowed indication allowed. The duration or ID field of the CTS may indicate the low latency EDCA grant duration and may set the NAV as the same NAV for legacy STAs 104 (such as the legacy STA 104-t). The UHR STAs 104 (such as the first UHR STA 104-u, the second UHR STA 104-v, and the third UHR STA 104-w) may contend for channel access using N maximum random time slots. The AP 102-f may use a multi-cast solicitation mechanism before sending the CTS.

As shown, the second UHR STA 104-v may succeed in the contention and transmit an uplink PPDU 1404 (labeled as “UL PPDU” in FIG. 14) that carries low latency traffic within the low latency EDCA grant duration.

In some examples, a STA 104 that used information from an RTS frame or a multiuser RTS trigger frame as the most recent basis to update the NAV setting for the STA 104 may be permitted to reset the NAV for the STA 104 if no PHY-RXEARLYSIG indication or PHY-RXSTART indication primitive is received from the PHY during a NAV timeout period starting when the MAC receives a PHY-RXEND indication primitive corresponding to the detection of the RTS frame or MU-RTS Trigger frame. In non-DMG BSS, the NAV Timeout period may be equal to (2×aSIFStime)+(CTS_Time)+(aR×PHYStartDelay)+(2×aSlotTime). In a non-SIG STA 104, (such as 11ax), if an RTS frame is used for the most recent NAV update, CTS_TIME may be calculated using the length of the CTS frame and the data rate at which the RTS frame used for the most recent NAV update was received. If a multiuser RTS trigger frame was used for the most recent NAV update, CTS_Time may be calculated using the length of the CTS frame and the 6 Mb/s data rate (multiuser RTS or Trigger/CTS frame exchange sequence procedure).

In some examples, after transmitting an RTS frame, the STA 104 may wait for a CTSTimeout interval with a value of aSIFSTime+aSlotTime+aRxPHYStartDelay. The interval begins when the MAC receives a PHYOTXEND.confirmprimitive. If a PHY-RXEARLYSIG.indication or PHY-RXSTART.indication primitive does not occur during the CTSTimeout interval, the STA may conclude that the transmission of the RTS frame has failed, and the STA may invoke its backoff procedure upon expiration of the CTSTimout interval. If a PHY-RXEARLYSIG.indication or PHY-RXSTART.indication primitive does occur during the CTSTimeout interval, the STA may wait for the corresponding PHY-RXEND.indication primitive to determine whether the RTS frame transmission was successful. The recognition of a valid CTS frame sent by the recipient of the RTS frame, corresponding to this PHY-RXEND.indication primitive may be interpreted as a successful response, permitting the frame exchange to continue. The recognition of anything else, including any other valid frame, may be interpreted as failure of the RTS frame transmission. The STA may invoke its backoff procedure at the PHY-RXEND.indication primitive and may process the received frame.

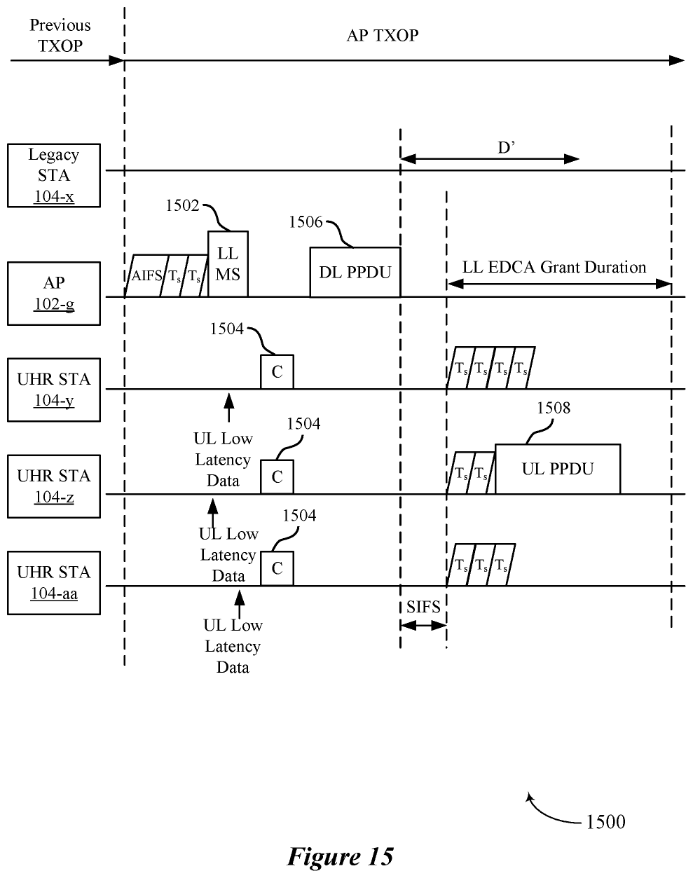

FIG. 15 shows an example of a timing diagram 1500 that includes an AP multi-cast solicitation mechanism before a low latency EDCA grant that supports low latency channel access. The timing diagram 1500 may implement or may be implemented by aspects of the wireless communication network 100. For example, the timing diagram 1500 may include an AP 102-g, which may be an example of an AP 102 as described herein. The timing diagram 1500 may include a legacy STA 104-x, a first UHR STA 104-y, a second UHR STA 104-z, and a third UHR STA 104-aa, which may be examples of STAs 104 as described herein.

After an AIFS and one or more time periods Tₛ, the AP 102-g may transmit a low latency multi-cast solicitation 1502 (labeled as “LL MS” in FIG. 15) to determine if the AP 102-g should send an EDCA grant. The low latency multi-cast solicitation 1502 may be signaling such as a low latency multiuser RTS or CTS and may be used to see if any STA 104 has pending low latency data.

Uplink low latency traffic may arrive at the first UHR STA 104-y, the second UHR STA 104-z, and the third UHR STA 104-aa, and according, each of the first UHR STA 104-y, the second UHR STA 104-z, and the third UHR STA 104-aa may transmit a response frame 1504 (such as an NDP or a CTS frame) that indicate that the first UHR STA 104-y, the second UHR STA 104-z, and the third UHR STA 104-aa, respectively, have uplink low latency traffic for transmission.

In response to the response frames 1504, the AP 102-g may transmit a downlink PPDU 1506 (labeled as “DL PPDU” in FIG. 15) that indicates preemption is allowed. The downlink PPDU 1506 may indicate a low latency EDCA grant duration. If the AP 102-g does not receive a response to the low latency multi-cast solicitation 1502, the AP 102-g may not include a preemption allowed indication in the downlink PPDU 1506. A SIFS duration after the downlink PPDU 1506, the first UHR STA 104-y, the second UHR STA 104-z, and the third UHR STA 104-aa may contend for channel access. As shown, the second UHR STA 104-z may succeed in the contention and transmit an uplink PPDU 1508 (labeled as “UL PPDU” in FIG. 15) that carries low latency traffic within the low latency EDCA grant duration. As shown, a time duration D′ refers to a time duration in which legacy STAs 104 (such as the legacy STA 104-x) may not access the channel (such as PIFS bursting or NAV/CTS timeout or the NAV duration).

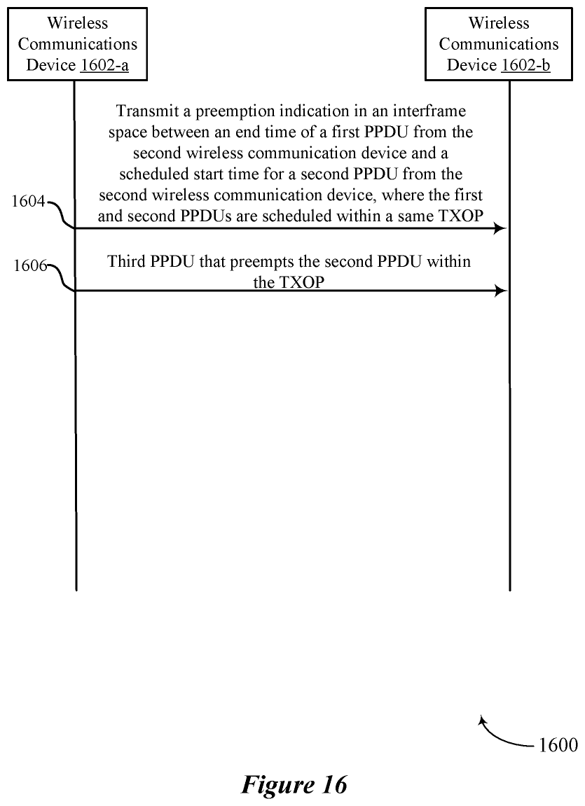

FIG. 16 shows an example of a process flow 1600 that supports low latency channel access. The process flow 1600 includes a first wireless communication device 1602-a and a second wireless communication device 1602-b, which may be examples of APs 102 or STAs 104 as described herein. In the following description of the process flow 1600, the operations between the first wireless communication device 1602-a and the second wireless communication device 1602-b may be transmitted in a different order than the example order shown, or the operations performed by the first wireless communication device 1602-a and the second wireless communication device 1602-b may be performed in different orders or at different times. Some operations also may be omitted from the process flow 1600, and other operations may be added to the process flow 1600.

At 1604, the first wireless communication device 1602-a may transmit, in an interframe space between an end time of a first PPDU from a second wireless communication device 1602-b and a scheduled start time for a second PPDU from the second wireless communication device 1602-b, a preemption indication associated with low latency data at the first wireless communication device, where the first PPDU and the second PPDU are scheduled within a TXOP associated with the second wireless communication device 1602-b.

At 1606, the first wireless communication device 1602-a may transmit, based on the preemption indication, a third PPDU, where the third PPDU preempts the second PPDU within the TXOP.

In some examples, the first wireless communication device 1602-a may receive in the first PPDU, a preemption allowed or a preemption enabled indication for the TXOP, where transmission of the preemption indication is based on the preemption allowed indication. In some examples, the preemption allowed indication indicates that preemption is allowed for an entirety of the TXOP. In some examples, the preemption allowed indication is included in one of a physical layer header of the first PPDU or a receiver address field of the first PPDU.

In some examples, the first wireless communication device 1602-a may transmit, to the second wireless communication device 1602-b in the interframe space, a response frame for the first PPDU, where transmission of the preemption indication is subsequent to transmission of the response frame. In some examples, the preemption indication is transmitted via a CTS frame. In some examples, the response frame may be a block acknowledgement.

In some examples, the first wireless communication device 1602-a may transmit a response for the first PPDU in a same frame as the preemption indication at 1604. In some examples, the first wireless communication device 1602-a receive, in the first PPDU, an indication of a broadcast RU for transmission of the preemption indication, and the preemption indication is transmitted via the broadcast RU.

In some examples, the first wireless communication device 1602-a may receive, from the second wireless communication device 1602-b, a frame in response to the preemption indication, and transmission of the third PPDU is responsive to the frame.

In some examples, the first wireless communication device 1602-a may perform, based on transmission of the preemption indication, a listen before talk (LBT) procedure within a time period after the preemption indication, where transmission of the third PPDU is based on the LBT procedure, where a duration of the time period is indicated by the second wireless communication device 1602-b to the first wireless communication device, and where transmission of the third PPDU is within a grant duration indicated by the second wireless communication device 1602-b to the first wireless communication device 1602-a. In some examples, the LBT procedure uses a sub-slot granularity to determine a starting time for the third PPDU, and a sub-slot has a duration of less than 9 microseconds (such as for 5 or 6 GHz channels which use 9 microsecond slots). In some examples, the sub-slot may have a duration of less than 20 microseconds (such as for 2.4 GHz channels which use 20 microsecond slots).

In some examples, the third PPDU is transmitted a period of time corresponding to a second interframe space after transmission of the preemption indication. In some examples, the first wireless communication device 1602-a may receive, from the second wireless communication device 1602-b, an indication of a duration of the second interframe space. In some examples, the period of time corresponding to a second interframe space may be a number of slots (such as the second wireless communication device 1602-b may indicate a number of slots as the duration of the second interframe space).

In some examples, the first wireless communication device 1602-a and the second wireless communication device 1602-b may receive, from a third wireless communication device in a second interframe space of the TXOP between an end time of the third PPDU and a scheduled start time for reception of a fourth PPDU from the second wireless communication device 1602-b, a second preemption indication associated with low latency data at the third wireless communication device, where the fourth PPDU is scheduled for reception within the TXOP. The first wireless communication device 1602-a may refrain from monitoring for the fourth PPDU based on the second preemption indication. The second wireless communication device 1602-b may receive, from the third wireless communication device and based on the second preemption indication, a fifth PPDU, where the fifth PPDU preempts the fourth PPDU within the TXOP. In some examples, the first wireless communication device 1602-a may receive, from the second wireless communication device 1602-b, a response frame for the third PPDU that includes a preemption allowed indication for the TXOP, and reception of the second preemption indication is responsive to the preemption allowed indication.

In some examples, the first wireless communication device 1602-a may refrain from monitoring for the second PPDU based on the preemption indication. In some examples, the second wireless communication device 1602-b may refrain from transmitting the second PPDU based on the preemption indication.

In some examples, the first wireless communication device 1602-a and the second wireless communication device 1602-b may scheduling information that schedules the first PPDU and the second PPDU within the TXOP.

In some examples, the first wireless communication device 1602-a is an AP and the second wireless communication device 1602-b is a STA. In some examples, the first wireless communication device 1602-a is a STA and the second wireless communication device 1602-b is an AP.

In some examples, the interframe space is one of a short interframe space, a point coordination function interframe space, or a contention window with random backoff.

[Inventors: Please describe any other ways that your invention can be built, performed or used differently from the way disclosed]

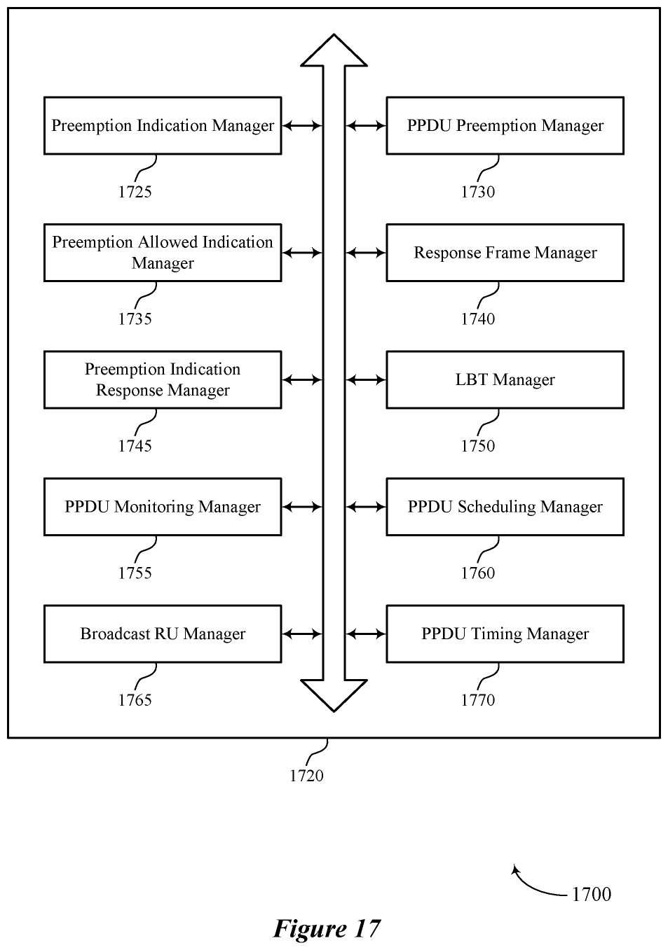

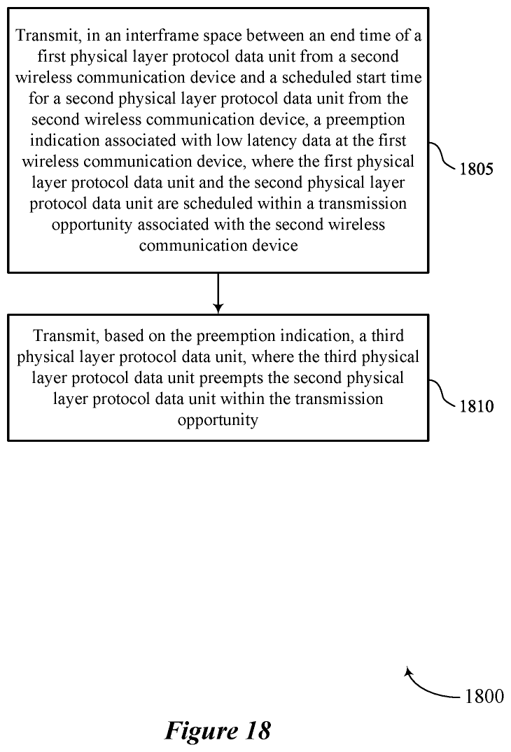

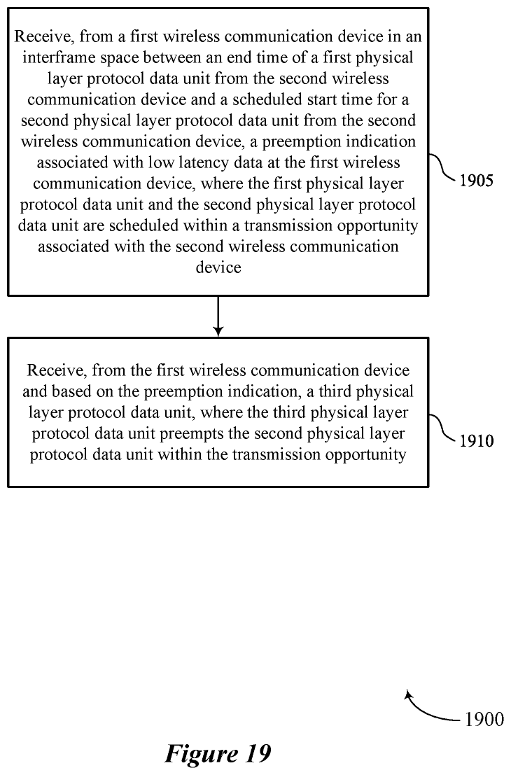

FIG. 17 shows a block diagram of an example wireless communication device 1700 that supports low latency channel access. In some examples, the wireless communication device 1700 is configured to perform the processes 1800 and 1900 described with reference to FIGS. 18 and 19, respectively. The wireless communication device 1700 may include one or more chips, SoCs, chipsets, packages, components or devices that individually or collectively constitute or include a processing system. The processing system may interface with other components of the wireless communication device 1700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1700 may transmit the information output from the chip. In such an example, the second interface may refer to an interface between the processing system of the chip and a reception component, such that the wireless communication device 1700 may receive information that is then passed to the processing system. In some such examples, the first interface also may obtain information, such as from the transmission component, and the second interface also may output information, such as to the reception component.

The processing system of the wireless communication device 1700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1700 can configurable or configured for use in an AP or STA, such as the AP 102 or the STA 104 described with reference to FIG. 1. In some other examples, the wireless communication device 1700 can be an AP or STA that includes such a processing system and other components including multiple antennas. The wireless communication device 1700 is capable of transmitting and receiving wireless communications in the form of, for example, wireless packets. For example, the wireless communication device 1700 can be configurable or configured to transmit and receive packets in the form of physical layer PPDUs and MPDUs conforming to one or more of the IEEE 802.11 family of wireless communication protocol standards. In some other examples, the wireless communication device 1700 can be configurable or configured to transmit and receive signals and communications conforming to one or more 3GPP specifications including those for 5G NR or 6G. In some examples, the wireless communication device 1700 also includes or can be coupled with one or more application processors which may be further coupled with one or more other memories. In some examples, the wireless communication device 1700 further includes a user interface (UI) (such as a touchscreen or keypad) and a display, which may be integrated with the UI to form a touchscreen display that is coupled with the processing system. In some examples, the wireless communication device 1700 may further include one or more sensors such as, for example, one or more inertial sensors, accelerometers, temperature sensors, pressure sensors, or altitude sensors, that are coupled with the processing system. In some examples, the wireless communication device 1700 further includes at least one external network interface coupled with the processing system that enables communication with a core network or backhaul network that enables the wireless communication device 1700 to gain access to external networks including the Internet.

The wireless communication device 1700 includes a preemption indication manager 1725, a PPDU preemption manager 1730, a preemption allowed indication manager 1735, a response frame manager 1740, a preemption indication response manager 1745, an LBT manager 1750, a PPDU monitoring manager 1755, a PPDU scheduling manager 1760, a broadcast RU manager 1765, and a PPDU timing manager 1770. Portions of one or more of the preemption indication manager 1725, the PPDU preemption manager 1730, the preemption allowed indication manager 1735, the response frame manager 1740, the preemption indication response manager 1745, the LBT manager 1750, the PPDU monitoring manager 1755, the PPDU scheduling manager 1760, the broadcast RU manager 1765, and the PPDU timing manager 1770 may be implemented at least in part in hardware or firmware. For example, one or more of the preemption indication manager 1725, the PPDU preemption manager 1730, the preemption allowed indication manager 1735, the response frame manager 1740, the preemption indication response manager 1745, the LBT manager 1750, the PPDU monitoring manager 1755, the PPDU scheduling manager 1760, the broadcast RU manager 1765, and the PPDU timing manager 1770 may be implemented at least in part by at least a processor or a modem. In some examples, portions of one or more of the preemption indication manager 1725, the PPDU preemption manager 1730, the preemption allowed indication manager 1735, the response frame manager 1740, the preemption indication response manager 1745, the LBT manager 1750, the PPDU monitoring manager 1755, the PPDU scheduling manager 1760, the broadcast RU manager 1765, and the PPDU timing manager 1770 may be implemented at least in part by a processor and software in the form of processor-executable code stored in memory.

The wireless communication device 1700 may include a communication manager 1720 and may support wireless communications in accordance with examples as disclosed herein. The preemption indication manager 1725 is configurable or configured to transmit, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device. The PPDU preemption manager 1730 is configurable or configured to transmit, based on the preemption indication, a third PPDU, where the third PPDU preempts the second PPDU within the TXOP.

In some examples, the preemption allowed indication manager 1735 is configurable or configured to receive, in the first PPDU, a preemption allowed indication for the TXOP, where transmission of the preemption indication is based on the preemption allowed indication.

In some examples, the preemption allow indication indicates that preemption is allowed for an entirety of the TXOP.

In some examples, the preemption allow indication is included in one of a physical layer header of the first PPDU or a receiver address field of the first PPDU.

In some examples, the response frame manager 1740 is configurable or configured to transmit, to the second wireless communication device in the interframe space, a response frame for the first PPDU, where transmission of the preemption indication is subsequent to transmission of the response frame.

In some examples, the preemption indication may be transmitted via a CTS frame.

In some examples, the preemption indication manager 1725 is configurable or configured to transmit a response for the first PPDU in a same frame as the preemption indication.

In some examples, the broadcast RU manager 1765 is configurable or configured to receive, in the first PPDU, an indication of a broadcast RU for transmission of the preemption indication, where the preemption indication is transmitted via the broadcast RU.

In some examples, the preemption indication response manager 1745 is configurable or configured to receive, from the second wireless communication device, a frame in response to the preemption indication, where transmission of the third PPDU is responsive to the frame.

In some examples, the LBT manager 1750 is configurable or configured to perform, based on transmission of the preemption indication, an LBT procedure within a time period after the preemption indication, where transmission of the third PPDU is based on the LBT procedure, where a duration of the time period is indicated by the second wireless communication device to the first wireless communication device, and where transmission of the third PPDU is within a grant duration indicated by the second wireless communication device to the first wireless communication device.

In some examples, the LBT procedure used a sub-slot granularity to determine a starting time for the third PPDU. In some examples, a sub-slot has a duration of less than 9 microseconds.

In some examples, the third PPDU is transmitted a period of time corresponding to a second interframe space after transmission of the preemption indication.

In some examples, the PPDU timing manager 1770 is configurable or configured to receive, from the second wireless communication device, an indication of a duration of the second interframe space.

In some examples, the preemption indication manager 1725 is configurable or configured to receive, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU is scheduled for reception within the TXOP. In some examples, the PPDU monitoring manager 1755 is configurable or configured to refrain from monitoring for the fourth PPDU based on the second preemption indication.

In some examples, the preemption allowed indication manager 1735 is configurable or configured to receive, from the second wireless communication device, a response frame for the third PPDU that includes a preemption allowed indication for the TXOP, where reception of the second preemption indication is responsive to the preemption allowed indication.

In some examples, the PPDU monitoring manager 1755 is configurable or configured to refrain from monitoring for the second PPDU based on the preemption indication.

In some examples, the PPDU scheduling manager 1760 is configurable or configured to receive scheduling information that schedules the first PPDU and the second PPDU within the TXOP.

In some examples, the first wireless communication device be an AP and the second wireless communication device is a STA. In some examples, the first wireless communication device be a STA and the second wireless communication device is an AP.

In some examples, the interframe space be one of a short interframe space, a point coordination function interframe space, or a contention window with random backoff.

Additionally, or alternatively, the wireless communication device 1700 may support wireless communications in accordance with examples as disclosed herein. In some examples, the preemption indication manager 1725 is configurable or configured to receive, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device. In some examples, the preemption indication manager 1725 is configurable or configured to receive, from the first wireless communication device and based on the preemption indication, a third PPDU, where the third PPDU preempts the second PPDU within the TXOP.

In some examples, the preemption allowed indication manager 1735 is configurable or configured to transmit, in the first PPDU, a preemption allowed indication for the TXOP, where transmission of the preemption indication is based on the preemption allowed indication.

In some examples, the preemption allow indication indicates that preemption is allowed for an entirety of the TXOP.

In some examples, the preemption allow indication is included in one of a physical layer header of the first PPDU or a receiver address field of the first PPDU.

In some examples, the response frame manager 1740 is configurable or configured to receive, from the first wireless communication device in the interframe space, a response frame for the first PPDU, where reception of the preemption indication is subsequent to reception of the response frame.

In some examples, the preemption indication be received via a CTS frame.

In some examples, the preemption indication manager 1725 is configurable or configured to receive, from the first wireless communication device, a response frame for the first PPDU in a same frame as the preemption indication.

In some examples, the broadcast RU manager 1765 is configurable or configured to transmit, in the first PPDU, an indication of a broadcast RU for transmission of the preemption indication, where the preemption indication is received via the broadcast RU.

In some examples, the preemption indication response manager 1745 is configurable or configured to transmit a frame in response to the preemption indication, where reception of the third PPDU is responsive to the frame.

In some examples, the third PPDU be received a period of time corresponding to a second interframe space after reception of the preemption indication.

In some examples, the PPDU timing manager 1770 is configurable or configured to transmit, to the first wireless communication device, an indication of a duration of the second interframe space.

In some examples, the preemption indication manager 1725 is configurable or configured to receive, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU is scheduled for reception within the TXOP. In some examples, the PPDU preemption manager 1730 is configurable or configured to receive, from the third wireless communication device and based on the second preemption indication, a fifth PPDU, where the fifth PPDU preempts the fourth PPDU within the TXOP.

In some examples, the preemption allowed indication manager 1735 is configurable or configured to transmit a response frame for the third PPDU that includes a preemption allowed indication for the TXOP, where reception of the second preemption indication is responsive to the preemption allowed indication.

In some examples, the PPDU preemption manager 1730 is configurable or configured to refrain from transmitting the second PPDU based on the preemption indication.

In some examples, the PPDU scheduling manager 1760 is configurable or configured to transmit scheduling information that schedules the first PPDU and the second PPDU within the TXOP.

In some examples, the first wireless communication device be an AP and the second wireless communication device is a STA. In some examples, the first wireless communication device be a STA and the second wireless communication device is an AP.

In some examples, the interframe space be one of a short interframe space, a point coordination function interframe space, or a contention window with random backoff.

FIG. 18 shows a flowchart illustrating an example process 1800 performable by or at a first wireless communication device that supports low latency channel access. The operations of the process 1800 may be implemented by a first wireless communication device or its components as described herein. For example, the process 1800 may be performed by a wireless communication device, such as the wireless communication device 1700 described with reference to FIG. 17, operating as or within a wireless AP or a wireless STA. In some examples, the process 1800 may be performed by a wireless AP or a wireless STA, such as one of the APs 102 or the STAs 104 described with reference to FIG. 1.

In some examples, in block 1805, the first wireless communication device may transmit, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device. The operations of block 1805 may be performed in accordance with examples as disclosed herein, such as transmission of a preemption indication 812 or a preemption indication 838 of FIG. 8, a preemption indication 906 of FIG. 9, a preemption indication 1006 of FIG. 10, or a preemption indication 1106 of FIG. 11. In some implementations, aspects of the operations of block 1805 may be performed by a preemption indication manager 1725 as described with reference to FIG. 17.

In some examples, in block 1810, the first wireless communication device may transmit, based on the preemption indication, a third PPDU, where the third PPDU preempts the second PPDU within the TXOP. The operations of block 1810 may be performed in accordance with examples as disclosed herein, such as transmission of an uplink PPDU 816 or an uplink PPDU 842 of FIG. 8, an uplink PPDU 910 of FIG. 9, an uplink PPDU 1012 of FIG. 10, or a downlink PPDU 1110 of FIG. 11. In some implementations, aspects of the operations of block 1810 may be performed by a PPDU preemption manager 1730 as described with reference to FIG. 17.

FIG. 19 shows a flowchart illustrating an example process 1900 performable by or at a second wireless communication device that supports low latency channel access. The operations of the process 1900 may be implemented by a second wireless communication device or its components as described herein. For example, the process 1900 may be performed by a wireless communication device, such as the wireless communication device 1700 described with reference to FIG. 17, operating as or within a wireless AP or a wireless STA. In some examples, the process 1900 may be performed by a wireless AP or a wireless STA, such as one of the APs 102 or the STAs 104 described with reference to FIG. 1.

In some examples, in block 1905, the second wireless communication device may receive, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device. The operations of block 1905 may be performed in accordance with examples as disclosed herein, such as reception of a preemption indication 812 or a preemption indication 838 of FIG. 8, a preemption indication 906 of FIG. 9, a preemption indication 1006 of FIG. 10, or a preemption indication 1106 of FIG. 11. In some implementations, aspects of the operations of block 1905 may be performed by a preemption indication manager 1725 as described with reference to FIG. 17.

In some examples, in block 1910, the second wireless communication device may receive, from the first wireless communication device and based on the preemption indication, a third PPDU, where the third PPDU preempts the second PPDU within the TXOP. The operations of block 1910 may be performed in accordance with examples as disclosed herein, such as reception of an uplink PPDU 816 or an uplink PPDU 842 of FIG. 8, an uplink PPDU 910 of FIG. 9, an uplink PPDU 1012 of FIG. 10, or a downlink PPDU 1110 of FIG. 11. In some implementations, aspects of the operations of block 1910 may be performed by a preemption indication manager 1725 as described with reference to FIG. 17.

Implementation examples are described in the following numbered clauses:

Aspect 1: A method for wireless communications at a first wireless communication device, including: transmitting, in an interframe space between an end time of a first PPDU from a second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device; and transmitting, based at least in part on the preemption indication, a third PPDU, where the third PPDU preempts the second PPDU within the TXOP.

Aspect 2: The method of aspect 1, further including: receiving, in the first PPDU, a preemption allowed indication for the TXOP, where transmission of the preemption indication is based at least in part on the preemption allowed indication.

Aspect 3: The method of aspect 2, where the preemption allowed indication indicates that preemption is allowed for an entirety of the TXOP.

Aspect 4: The method of any of aspects 2-3, where the preemption allowed indication is included in one of a physical layer header of the first PPDU or a receiver address field of the first PPDU.

Aspect 5: The method of any of aspects 1-4, further including: transmitting, to the second wireless communication device in the interframe space, a response frame for the first PPDU, where transmission of the preemption indication is subsequent to transmission of the response frame.

Aspect 6: The method of aspect 5, where the preemption indication is transmitted via a CTS frame.

Aspect 7: The method of any of aspects 1-4, further including: transmitting a response for the first PPDU in a same frame as the preemption indication.

Aspect 8: The method of aspect 7, further including: receiving, in the first PPDU, an indication of a broadcast RU for transmission of the preemption indication, where the preemption indication is transmitted via the broadcast RU.

Aspect 9: The method of any of aspects 1-8, further including: receiving, from the second wireless communication device, a frame in response to the preemption indication, where transmission of the third PPDU is responsive to the frame.

Aspect 10: The method of any of aspects 1-9, further including: performing, based on transmission of the preemption indication, an LBT procedure within a time period after the preemption indication, where transmission of the third PPDU is based at least in part on the LBT procedure, where a duration of the time period is indicated by the second wireless communication device to the first wireless communication device, and where transmission of the third PPDU is within a grant duration indicated by the second wireless communication device to the first wireless communication device.

Aspect 11: The method of aspect 10, where the LBT procedure uses a sub-slot granularity to determine a starting time for the third PPDU, a sub-slot has a duration of less than 9 microseconds.

Aspect 12: The method of any of aspects 1-11, where the third PPDU is transmitted a period of time corresponding to a second interframe space after transmission of the preemption indication.

Aspect 13: The method of aspect 12, further including: receiving, from the second wireless communication device, an indication of a duration of the second interframe space.

Aspect 14: The method of any of aspects 1-13, further including: receiving, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU is scheduled for reception within the TXOP; and refraining from monitoring for the fourth PPDU based at least in part on the second preemption indication.

Aspect 15: The method of aspect 14, further including: receiving, from the second wireless communication device, a response frame for the third PPDU that includes a preemption allowed indication for the TXOP, where reception of the second preemption indication is responsive to the preemption allowed indication.

Aspect 16: The method of any of aspects 1-15, further including: refraining from monitoring for the second PPDU based at least in part on the preemption indication.

Aspect 17: The method of any of aspects 1-16, further including: receiving scheduling information that schedules the first PPDU and the second PPDU within the TXOP.

Aspect 18: The method of any of aspects 1-17, where the first wireless communication device is an access point and the second wireless communication device is a station; or the first wireless communication device is a station and the second wireless communication device is an access point.

Aspect 19: The method of any of aspects 1-18, where the interframe space is one of a short interframe space, a point coordination function interframe space, or a contention window with random backoff.

Aspect 20: A method for wireless communications at a second wireless communication device, including: receiving, from a first wireless communication device in an interframe space between an end time of a first PPDU from the second wireless communication device and a scheduled start time for a second PPDU from the second wireless communication device, a preemption indication associated with low latency data at the first wireless communication device, where the first PPDU and the second PPDU are scheduled within a TXOP associated with the second wireless communication device; and receiving, from the first wireless communication device and based at least in part on the preemption indication, a third PPDU, where the third PPDU preempts the second PPDU within the TXOP.

Aspect 21: The method of aspect 20, further including: transmitting, in the first PPDU, a preemption allowed indication for the TXOP, where reception of the preemption indication is based at least in part on the preemption allowed indication.

Aspect 22: The method of aspect 21, where the preemption allowed indication indicates that preemption is allowed for an entirety of the TXOP.

Aspect 23: The method of any of aspects 21-22, where the preemption allowed indication is included in one of a physical layer header of the first PPDU or a receiver address field of the first PPDU.

Aspect 24: The method of any of aspects 20-23, further including: receiving, from the first wireless communication device in the interframe space, a response frame for the first PPDU, where reception of the preemption indication is subsequent to reception of the response frame.

Aspect 25: The method of aspect 24, where the preemption indication is received via a CTS frame.

Aspect 26: The method of any of aspects 20-23, further including: receiving, from the first wireless communication device, a response frame for the first PPDU in a same frame as the preemption indication.

Aspect 27: The method of aspect 26, further including: transmitting, in the first PPDU, an indication of a broadcast RU for transmission of the preemption indication, where the preemption indication is received via the broadcast RU.

Aspect 28: The method of any of aspects 20-27, further including: transmitting a frame in response to the preemption indication, where reception of the third PPDU is responsive to the frame.

Aspect 29: The method of any of aspects 20-28, where the third PPDU is received a period of time corresponding to a second interframe space after reception of the preemption indication.

Aspect 30: The method of aspect 29, further including: transmitting, to the first wireless communication device, an indication of a duration of the second interframe space.

Aspect 31: The method of any of aspects 20-30, further including: receiving, from a third wireless communication device in a second interframe space of the TXOP between an end time of the third PPDU and a scheduled start time for reception of a fourth PPDU from the second wireless communication device, a second preemption indication associated with low latency data at the third wireless communication device, where the fourth PPDU is scheduled for reception within the TXOP; and receiving, from the third wireless communication device and based at least in part on the second preemption indication, a fifth PPDU, where the fifth PPDU preempts the fourth PPDU within the TXOP.

Aspect 32: The method of aspect 31, further including: transmitting a response frame for the third PPDU that includes a preemption allowed indication for the TXOP, where reception of the second preemption indication is responsive to the preemption allowed indication.

Aspect 33: The method of any of aspects 20-32, further including: refraining from transmitting the second PPDU based at least in part on the preemption indication.

Aspect 34: The method of any of aspects 20-33, further including: transmitting scheduling information that schedules the first PPDU and the second PPDU within the TXOP.

Aspect 35: The method of any of aspects 20-34, where the first wireless communication device is an access point and the second wireless communication device is a station; or the first wireless communication device is a station and the second wireless communication device is an access point.

Aspect 36: The method of any of aspects 20-35, where the interframe space is one of a short interframe space, a point coordination function interframe space, or a contention window with random backoff.

Aspect 37: A first wireless communication device for wireless communications, including one or more memories storing processor-executable code, and one or more processors coupled with the one or more memories and individually or collectively operable to execute the code to cause the first wireless communication device to perform a method of any of aspects 1-19.

Aspect 38: A first wireless communication device for wireless communications, including at least one means for performing a method of any of aspects 1-19.

Aspect 39: A non-transitory computer-readable medium storing code for wireless communications, the code including instructions executable by a processor to perform a method of any of aspects 1-19.

Aspect 40: A second wireless communication device for wireless communications, including one or more memories storing processor-executable code, and one or more processors coupled with the one or more memories and individually or collectively operable to execute the code to cause the second wireless communication device to perform a method of any of aspects 20-36.

Aspect 41: A second wireless communication device for wireless communications, including at least one means for performing a method of any of aspects 20-36.

Aspect 42: A non-transitory computer-readable medium storing code for wireless communications, the code including instructions executable by a processor to perform a method of any of aspects 20-36.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
one or more memories storing processor-executable code; and
one or more processors coupled with the one or more memories and individually or collectively operable to execute the code to cause the first wireless communication device to:
transmit, in an interframe space between an end time of a first physical layer protocol data unit from a second wireless communication device and a scheduled start time for a second physical layer protocol data unit from the second wireless communication device, a preemption indication associated with low latency data at the first wireless communication device, wherein the first physical layer protocol data unit and the second physical layer protocol data unit are scheduled within a transmission opportunity associated with the second wireless communication device; and
transmit, based at least in part on the preemption indication, a third physical layer protocol data unit, wherein the third physical layer protocol data unit preempts the second physical layer protocol data unit within the transmission opportunity.

2. The first wireless communication device of claim 1, wherein the one or more processors are individually or collectively further operable to execute the code to cause the first wireless communication device to:
receive, in the first physical layer protocol data unit, a preemption allowed indication for the transmission opportunity, wherein transmission of the preemption indication is based at least in part on the preemption allowed indication.

3. The first wireless communication device of claim 2, wherein the preemption allowed indication indicates that preemption is allowed for an entirety of the transmission opportunity.

4. The first wireless communication device of claim 2, wherein the preemption allowed indication is included in one of a physical layer header of the first physical layer protocol data unit or a receiver address field of the first physical layer protocol data unit.

5. The first wireless communication device of claim 1, wherein the one or more processors are individually or collectively further operable to execute the code to cause the first wireless communication device to:
transmit, to the second wireless communication device in the interframe space, a response frame for the first physical layer protocol data unit, wherein transmission of the preemption indication is subsequent to transmission of the response frame.

6. The first wireless communication device of claim 5, wherein the preemption indication is transmitted via a clear to send frame.

7. The first wireless communication device of claim 1, wherein the one or more processors are individually or collectively further operable to execute the code to cause the first wireless communication device to:
transmit a response for the first physical layer protocol data unit in a same frame as the preemption indication.

8. The first wireless communication device of claim 7, wherein the one or more processors are individually or collectively further operable to execute the code to cause the first wireless communication device to:
receive, in the first physical layer protocol data unit, an indication of a broadcast resource unit for transmission of the preemption indication, wherein the preemption indication is transmitted via the broadcast resource unit.

9. The first wireless communication device of claim 1, wherein the one or more processors are individually or collectively further operable to execute the code to cause the first wireless communication device to:
receive, from the second wireless communication device, a frame in response to the preemption indication, wherein transmission of the third physical layer protocol data unit is responsive to the frame.

10. The first wireless communication device of claim 1, wherein the one or more processors are individually or collectively further operable to execute the code to cause the first wireless communication device to:
perform, based on transmission of the preemption indication, a listen before talk procedure within a time period after the preemption indication, wherein transmission of the third physical layer protocol data unit is based at least in part on the listen before talk procedure, wherein a duration of the time period is indicated by the second wireless communication device to the first wireless communication device, and wherein transmission of the third physical layer protocol data unit is within a grant duration indicated by the second wireless communication device to the first wireless communication device.

11. The first wireless communication device of claim 10, wherein:
the listen before talk procedure uses a sub-slot granularity to determine a starting time for the third physical layer protocol data unit, and
a sub-slot has a duration of less than 9 microseconds.

12. The first wireless communication device of claim 1, wherein the third physical layer protocol data unit is transmitted a period of time corresponding to a second interframe space after transmission of the preemption indication.

13. The first wireless communication device of claim 12, wherein the one or more processors are individually or collectively further operable to execute the code to cause the first wireless communication device to:
receive, from the second wireless communication device, an indication of a duration of the second interframe space.

14. The first wireless communication device of claim 1, wherein the one or more processors are individually or collectively further operable to execute the code to cause the first wireless communication device to:
receive, from a third wireless communication device in a second interframe space of the transmission opportunity between an end time of the third physical layer protocol data unit and a scheduled start time for reception of a fourth physical layer protocol data unit from the second wireless communication device, a second preemption indication associated with low latency data at the third wireless communication device, wherein the fourth physical layer protocol data unit is scheduled for reception within the transmission opportunity; and
refrain from monitoring for the fourth physical layer protocol data unit based at least in part on the second preemption indication.

15. The first wireless communication device of claim 14, wherein the one or more processors are individually or collectively further operable to execute the code to cause the first wireless communication device to:
receive, from the second wireless communication device, a response frame for the third physical layer protocol data unit that includes a preemption allowed indication for the transmission opportunity, wherein reception of the second preemption indication is responsive to the preemption allowed indication.

16. The first wireless communication device of claim 1, wherein the one or more processors are individually or collectively further operable to execute the code to cause the first wireless communication device to:
refrain from monitoring for the second physical layer protocol data unit based at least in part on the preemption indication.

17. The first wireless communication device of claim 1, wherein the one or more processors are individually or collectively further operable to execute the code to cause the first wireless communication device to:
receive scheduling information that schedules the first physical layer protocol data unit and the second physical layer protocol data unit within the transmission opportunity.

18. The first wireless communication device of claim 1, wherein:
the first wireless communication device is an access point and the second wireless communication device is a station; or
the first wireless communication device is a station and the second wireless communication device is an access point.

19. The first wireless communication device of claim 1, wherein the interframe space is one of a short interframe space, a point coordination function interframe space, or a contention window with random backoff.

20. A second wireless communication device, comprising:
one or more memories storing processor-executable code; and
one or more processors coupled with the one or more memories and individually or collectively operable to execute the code to cause the second wireless communication device to:
receive, from a first wireless communication device in an interframe space between an end time of a first physical layer protocol data unit from the second wireless communication device and a scheduled start time for a second physical layer protocol data unit from the second wireless communication device, a preemption indication associated with low latency data at the first wireless communication device, wherein the first physical layer protocol data unit and the second physical layer protocol data unit are scheduled within a transmission opportunity associated with the second wireless communication device; and
receive, from the first wireless communication device and based at least in part on the preemption indication, a third physical layer protocol data unit, wherein the third physical layer protocol data unit preempts the second physical layer protocol data unit within the transmission opportunity.

21. The second wireless communication device of claim 20, wherein the one or more processors are individually or collectively further operable to execute the code to cause the second wireless communication device to:
transmit, in the first physical layer protocol data unit, a preemption allowed indication for the transmission opportunity, wherein reception of the preemption indication is based at least in part on the preemption allowed indication.

22. The second wireless communication device of claim 21, wherein the preemption allowed indication is included in one of a physical layer header of the first physical layer protocol data unit or a receiver address field of the first physical layer protocol data unit.

23. The second wireless communication device of claim 20, wherein the one or more processors are individually or collectively further operable to execute the code to cause the second wireless communication device to:
receive, from the first wireless communication device in the interframe space, a response frame for the first physical layer protocol data unit, wherein reception of the preemption indication is subsequent to reception of the response frame.

24. The second wireless communication device of claim 20, wherein the one or more processors are individually or collectively further operable to execute the code to cause the second wireless communication device to:
receive, from the first wireless communication device, a response frame for the first physical layer protocol data unit in a same frame as the preemption indication.

25. The second wireless communication device of claim 24, wherein the one or more processors are individually or collectively further operable to execute the code to cause the second wireless communication device to:
transmit, in the first physical layer protocol data unit, an indication of a broadcast resource unit for transmission of the preemption indication, wherein the preemption indication is received via the broadcast resource unit.

26. The second wireless communication device of claim 20, wherein the one or more processors are individually or collectively further operable to execute the code to cause the second wireless communication device to:
transmit a frame in response to the preemption indication, wherein
reception of the third physical layer protocol data unit is responsive to the frame.

27. The second wireless communication device of claim 20, wherein the one or more processors are individually or collectively further operable to execute the code to cause the second wireless communication device to:
receive, from a third wireless communication device in a second interframe space of the transmission opportunity between an end time of the third physical layer protocol data unit and a scheduled start time for reception of a fourth physical layer protocol data unit from the second wireless communication device, a second preemption indication associated with low latency data at the third wireless communication device, wherein the fourth physical layer protocol data unit is scheduled for reception within the transmission opportunity; and
receive, from the third wireless communication device and based at least in part on the second preemption indication, a fifth physical layer protocol data unit, wherein the fifth physical layer protocol data unit preempts the fourth physical layer protocol data unit within the transmission opportunity.

28. The second wireless communication device of claim 27, wherein the one or more processors are individually or collectively further operable to execute the code to cause the second wireless communication device to:
transmit a response frame for the third physical layer protocol data unit that includes a preemption allowed indication for the transmission opportunity, wherein reception of the second preemption indication is responsive to the preemption allowed indication.

29. A method for wireless communications at a first wireless communication device, comprising:
transmitting, in an interframe space between an end time of a first physical layer protocol data unit from a second wireless communication device and a scheduled start time for a second physical layer protocol data unit from the second wireless communication device, a preemption indication associated with low latency data at the first wireless communication device, wherein the first physical layer protocol data unit and the second physical layer protocol data unit are scheduled within a transmission opportunity associated with the second wireless communication device; and
transmitting, based at least in part on the preemption indication, a third physical layer protocol data unit, wherein the third physical layer protocol data unit preempts the second physical layer protocol data unit within the transmission opportunity.

30. A method for wireless communications at a second wireless communication device, comprising:
receiving, from a first wireless communication device in an interframe space between an end time of a first physical layer protocol data unit from the second wireless communication device and a scheduled start time for a second physical layer protocol data unit from the second wireless communication device, a preemption indication associated with low latency data at the first wireless communication device, wherein the first physical layer protocol data unit and the second physical layer protocol data unit are scheduled within a transmission opportunity associated with the second wireless communication device; and
receiving, from the first wireless communication device and based at least in part on the preemption indication, a third physical layer protocol data unit, wherein the third physical layer protocol data unit preempts the second physical layer protocol data unit within the transmission opportunity.
